(19) United States
(12) Patent Application Publication
(10) Pub. No.: US 2024/0378649 A1
(43) Pub. Date: Nov. 14, 2024

(54) SYSTEMS AND METHODS FOR AUTONOMOUSLY GENERATING AND MAINTAINING REAL-TIME TOKENIZED ASSESSMENTS

(71) Applicant: State Farm Mutual Automobile Insurance Company, Bloomington, IL (US)

(72) Inventors: Seth L. Corin, Cumming, GA (US); Aaron Williams, Congerville, IL (US); Chad A. Akin, Lewisville, TX (US)

(21) Appl. No.: 18/784,741

(22) Filed: Jul. 25, 2024

Related U.S. Application Data
(60) Provisional application No. 63/604,729, filed on Nov. 30, 2023.
(60) Provisional application No. 63/589,785, filed on Oct. 12, 2023.
(60) Provisional application No. 63/421,723, filed on Nov. 2, 2022.

(51) Int. Cl. G06Q 30/0282

(52) U.S. Cl. CPC G06Q 30/0282

(57) ABSTRACT

A computer system for generating and maintaining non-fungible tokens for real-time subject assessment is described herein. The computer system includes a processor in communication with a memory device, the processor programmed to: (i) receive a plurality of data associated with a history of a subject, (ii) execute a model with the data to generate a subject rating for the subject and a recommendation of at least one recommended action that would improve the subject rating, (iii) generate a non-fungible token (NFT) including one or more of: the plurality of data, the subject rating, or the recommendation; (iv) monitor actions of the subject to determine if the at least one recommended action was performed; and (v) re-execute the at least one model with the plurality of data and updated data based upon the actions of the subject and the at least one recommended action to generate an updated subject rating.

### CROSS-REFERENCE TO RELATED APPLICATIONS

The present application claims the benefit of priority to U.S. Provisional Patent Application No. 63/604,729, filed Nov. 30, 2023, U.S. Provisional Patent Application No. 63/421,723, filed on Nov. 2, 2022, to U.S. Provisional Patent Application No. 63/589,785, filed Oct. 12, 2023, the entire contents of each of which are hereby incorporated by reference herein.

### FIELD OF THE DISCLOSURE

The present disclosure relates to generating and maintaining artificial intelligence models and, more particularly, to network-based systems and methods for autonomously generating and maintaining real-time subject and object assessment systems.

### BACKGROUND

There are many situations in which assessing and evaluating an object's history or a subject's history is useful or necessary. For example, when selling, purchasing, leasing, or insuring an object, it may be beneficial to have an accurate and complete history of the object, to improve any assessment or evaluation of that object. However, in many instances, an object's known history may be limited, and frequently out of date. In further instances, certain aspects of an object's history may be difficult to discern and/or monitor. As another example, when evaluating a subject's recorded vehicle usage history, such a history may not accurately reflect the subject's driving behavior.

Additionally, it advantageous to have up-to-date analysis of subjects, including objects, individuals, or groups of individuals. The up-to-date analysis allows for real-time assessment of the behavior and/or condition of the subject in question. This up-to-date analysis also enables encouraging good behavior with regard to actions related to the subject in question.

Accordingly, it would be useful to have a system for securely collecting, storing, updating, and analyzing real-time information relating to objects and subjects and providing access to that information as needed. The systems and methods disclosed herein may also provide solutions to the ineffectiveness, insecurities, difficulties, inefficiencies, encumbrances, and/or other drawbacks of conventional techniques.

### BRIEF SUMMARY

The present embodiments may relate to, inter alia, systems and methods for providing enhanced subject and object assessment using automated NFT generating and maintenance. A computer system, as described herein, may include a token management (TM) computer device that is in networked communication with a plurality of remote data sources, including data storage devices and sensors. The TM computer device may be configured to: (i) receive a plurality of data associated with an object history of an object; (ii) generate a container file for the object history to include the plurality of data; (iii) generate a non-fungible token (NFT) for the object based upon the container file; (iv) store the NFT and the container file for the object; (v) retrieve the NFT to access the plurality of data; and/or (vi) input the plurality of data to a trained model to receive an initial object assessment as output from the trained model.

The TM computer device may additionally be configured to: (i) receive a plurality of data associated with a subject history of a subject; (ii) generate a container file for the subject history to include the plurality of data; (iii) generate a non-fungible token (NFT) for the subject based upon the container file; (iv) store the NFT and the container file for the subject; (v) retrieve the NFT to access the plurality of data; and/or (vi) input the plurality of data to a trained model to receive an initial subject assessment as output from the trained model.

The TM computing device may additionally be configured to: (i) receive a plurality of data associated with a history of a subject; (ii) execute at least one model with the plurality of data to generate a subject rating for the subject and a recommendation of at least one recommended action that would improve the subject rating; (iii) generate a non-fungible token (NFT) including one or more of: the plurality of data, the subject rating, or the recommendation; (iv) monitor actions of the subject to determine if the at least one recommended action was performed; and/or (v) re-execute the at least one model with the plurality of data and updated data based upon the actions of the subject and the at least one recommended action to generate an updated subject rating.

In one aspect, a computer system may be provided. The computer platform may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be (1) in wired or wireless communication with one another, and/or (2) operate as input and/or output devices. For instance, the computer platform may include a token management (TM) computing device programmed to: (i) receive a plurality of data associated with a history of a subject; (ii) execute at least one model with the plurality of data to generate a subject rating for the subject and a recommendation of at least one recommended action that would improve the subject rating; (iii) generate a non-fungible token (NFT) including one or more of: the plurality of data, the subject rating, or the recommendation; (iv) monitor actions of the subject to determine if the at least one recommended action was performed; and/or (v) re-execute the at least one model with the plurality of data and updated data based upon the actions of the subject and the at least one recommended action to generate an updated subject rating. The computer platform may have additional, less, or alternative components and/or functionality.

In one aspect, a computer system for providing enhanced object assessment using automated NFT generation and maintenance is described. The computer system may include one or more local or remote processors, sensors, transceivers, servers, memory units, mobile devices, augmented reality glasses or headsets, extended or virtual reality headsets, smart glasses or watches, wearables, and/or other electronic or electrical components. In one instance, the computer system may include at least one processor in communication with at least one memory device. The at least one processor may be programmed to: (i) receive a plurality of data associated with an object history of an object; (ii) generate a container file for the object history to include the plurality of data; (iii) generate a non-fungible token (NFT) for the object based upon the container file; (iv) store the NFT and the container file for the object; (v) retrieve the NFT to access the plurality of data; and/or (vi) input the plurality of data to a trained model to receive an initial object assessment as output from the trained model. The computer system may have additional, less, or alternate functionality, including that discussed elsewhere herein. Methods and programs (e.g., at least one non-transitory computer-readable storage media having computer-executable instructions embodied thereon) for implementing the same may also be provided.

For instance, a computer-implemented method may provide enhanced object assessment using automated NFT generating and maintenance. The method may be implemented via one or more local or remote processors, sensors, transceivers, servers, memory units, mobile devices, augmented reality glasses or headsets, extended or virtual reality headsets, smart glasses or watches, wearables, and/or other electronic or electrical components. In one instance, the method may include: (i) receiving, via one or more processors and/or associated transceivers, a plurality of data associated with an object history of an object; (ii) generating, via the one or more processors, a container file for the object history to include the plurality of data; (iii) generating, via the one or more processors, a non-fungible token (NFT) for the object based upon the container file; (iv) storing, via the one or more processors, the NFT and the container file for the object; (v) retrieving, via the one or more processors, the NFT to access the plurality of data; and/or (vi) inputting, via the one or more processors, the plurality of data to a trained model to receive an initial object assessment as output from the trained model. The method may include additional, fewer, or alternate actions, including those discussed elsewhere herein.

In another aspect, a computer system for providing enhanced subject assessment using automated NFT generation and maintenance is described. The computer system may include one or more local or remote processors, sensors, transceivers, servers, memory units, mobile devices, augmented reality glasses or headsets, extended or virtual reality headsets, smart glasses or watches, wearables, and/or other electronic or electrical components. In one instance, the computer system may include at least one processor in communication with at least one memory device. The at least one processor may be programmed to: (i) receive a plurality of data associated with a subject history of a subject; (ii) generate a container file for the subject history to include the plurality of data; (iii) generate a non-fungible token (NFT) for the subject based upon the container file; (iv) store the NFT and the container file for the subject; (v) retrieve the NFT to access the plurality of data; and/or (vi) input the plurality of data to a trained model to receive an initial subject assessment as output from the trained model. The computer system may have additional, less, or alternate functionality, including that discussed elsewhere herein. Methods and programs (e.g., at least one non-transitory computer-readable storage media having computer-executable instructions embodied thereon) for implementing the same may also be provided.

In some aspects, a computer-implemented or computer-based method for providing enhanced subject assessment using automated NFT generating and maintenance may be implemented by a computing device, such as the TM computing device. The method may include (i) receiving a plurality of data associated with a subject history of a subject; (ii) generating a container file for the subject history to include the plurality of data; (iii) generating a non-fungible token (NFT) for the subject based upon the container file; (iv) storing the NFT and the container file for the subject; (v) retrieving the NFT to access the plurality of data; and/or (iv) inputting the plurality of data to a trained model to receive an initial subject assessment as output from the trained model. The computer-implemented method may include additional, fewer, or alternate actions, including those discussed elsewhere herein.

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include a computing device that may include at least one processor in communication with at least one memory device. The at least one processor may be configured to: (i) receive a plurality of data associated with a history of a subject; (ii) execute at least one model with the plurality of data of the history of the subject to determine a rating for the subject; (iii) execute the at least one model with the plurality of data of the history of the subject to determine at least one recommendation of at least one action that would improve the rating of the subject; (iv) monitor one or more actions of the subject to determine if the at least one action was performed; and/or (v) update the at least one model based upon the one or more actions of the subject and the at least one action. The computer system may include additional, less, or alternate functionality, including that discussed elsewhere herein.

In another aspect, a computer-implemented method may be provided. The computer-implemented method may be performed by a computer device including at least one processor in communication with at least one memory device. The method may include: (i) receiving, via one or more processors and/or associated transceivers, a plurality of data associated with a history of a subject; (ii) executing, via one or more processors and/or associated transceivers, at least one model with the plurality of data of the history of the subject to determine a rating for the subject; (iii) executing, via one or more processors and/or associated transceivers, the at least one model to with the plurality of data of the history of the subject to determine at least one recommendation of at least one action that would improve the rating of the subject; (iv) monitoring, via one or more processors and/or associated transceivers, one or more actions of the subject to determine if the at least one action was performed; and/or (v) updating, via one or more processors and/or associated transceivers, the at least one model based upon the one or more actions of the subject and the at least one action. The computer-implemented method may include additional, fewer, or alternate actions, including those discussed elsewhere herein.

In another aspect, at least one non-transitory computer-readable media having computer-executable instructions embodied thereon may be provided. When executed by a computing device including at least one processor in communication with at least one memory device, the computer-executable instructions may cause the at least one processor to: (i) receive a plurality of data associated with a history of a plurality of subjects; (ii) execute at least one model with the plurality of data of the history of the plurality of subjects to determine a rating for each of the plurality of subjects; (iii) execute the at least one model to with the plurality of data of the history of the plurality of subjects to determine at least one recommendation of at least one action that would improve the rating of the corresponding subject; (iv) monitor one or more actions of the corresponding subjects to determine if the at least one action was performed; and/or (v) update the at least one model based upon the one or more actions of the corresponding subjects and the at least one action. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements that are presently discussed herein. However, it should be understood, that the present embodiments are not limited to the precise arrangements and/or instrumentalities shown herein.

FIG. 1 illustrates a flow chart of an exemplary process for generating and maintaining NFTs related to object histories and assessments in accordance with one embodiment of this disclosure.

FIG. 2 illustrates a simplified block diagram of an exemplary computer system for implementing the processes shown in FIG. 1 and FIG. 6.

FIG. 3 illustrates a flow chart of an exemplary computer-implemented process for generating and maintaining NFTs related to object histories and assessments, using the system shown in FIG. 2.

FIG. 4 illustrates an exemplary configuration of a client computer device shown in FIG. 2, in accordance with one embodiment of the present disclosure.

FIG. 5 illustrates an exemplary configuration of a server shown in FIG. 2, in accordance with one embodiment of the present disclosure.

FIG. 6 illustrates a flow chart of an exemplary process for generating and maintaining NFTs related to subject histories and assessments in accordance with one embodiment of this disclosure.

FIG. 7 illustrates a flow chart of an exemplary computer-implemented process for generating and maintaining NFTs related to subject histories and assessments, which may include object histories and assessments, using the system shown in FIG. 2.

FIG. 8 illustrates a flow chart of an exemplary process for generating and maintaining one or more static rating models in accordance with one embodiment of this disclosure.

FIG. 9 illustrates a flow chart of an exemplary process for generating and maintaining one or more dynamic rating models in accordance with one embodiment of this disclosure.

FIG. 10 illustrates a flow chart of an exemplary computer-implemented process for generating and maintaining one or more rating models, using the system shown in FIG. 2.

FIG. 11 illustrates a flow chart of another exemplary process for generating and maintaining NFTs.

FIG. 12 illustrates a flow chart of an exemplary computer-implemented process for generating and maintaining one or more rating models, using the system shown in FIG. 2.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for generating and maintaining tokens, including non-fungible tokens (NFTs), and, more particularly, to network-based systems and methods for autonomously generating and maintaining NFTs for real-time object and subject evaluation. A computer system, as described herein, may include a token management (TM) computing device (also referred to as a “TM server”) that is in communication with a plurality of data sources or third-party devices, a plurality of sensors, and one or more user computing devices.

As used herein, “objects” may include personal property, vehicles, homes, and/or other buildings, including objects that are owned as well as objects that are leased or rented (part-time or full-time). In at least some embodiments, “objects” may broadly encompass any item or property that would be assessed during the purchase, sale, or insuring of the item. As used herein, “subjects” may include objects as well as persons or groups thereof. Such persons may include, for example, users or owners of objects, including (but not limited to) property owners, property occupants, property lessors, property users/renters/lessees, tenants, vehicle owners, vehicle users/renters/lessees, persons using ride-share applications as drivers and/or passengers, persons using one or more vehicles within a fleet of vehicles, users/renters of other personal mobility vehicles (e.g., bicycles, scooters), users or owners of insured objects (e.g., jewelry, art), and the like. Accordingly, where reference is made to a “subject,” such reference may also encompass an “object.” Although reference to both subject(s) and object(s) may be made herein, such reference is made for purposes of clarity and explanation and should not be construed as limiting.

Assessing objects may be performed in the course of buying, selling, leasing, and/or insuring an object. It may be generally known to perform a one-time assessment of an object based upon static history data elements. For example, in the case of insuring a vehicle, an insurance policy may be developed based upon an associated driving record, vehicle characteristics, location, and the like. As another example, to insure a home or other property, the insurance policy may be developed based upon credit score, location of home, age of home, and the like.

Assessing subjects may also occur at various times, including when a subject is buying, selling, leasing/renting, using, and/or insuring an object, starting a new job, operating within a “gig economy” role (e.g., as driver, passenger, lessor, lessee, etc.), and/or experiencing other significant life events. It may be generally known to perform an assessment of a subject based upon static history data elements (e.g., a credit score, financial records, etc.).

Notably, however, these assessments may be performed only once (e.g., at one stage of policy underwriting) and may be made based upon stale or outdated information. Moreover, certain information may be inaccurate or incomplete. When an entity is making a decision based upon such an assessment (e.g., to purchase a home, insure a property, insure a person or household, hire a person for a role, etc.), these limitations may affect their decision-making ability or the ultimate outcome of their decision.

In the exemplary embodiment of the present disclosure, an object history or a subject history is developed by collecting (e.g., receiving, retrieving, etc.) data associated with the object or subject, respectively, from a plurality of sources. These sources may include reference sources, such as insurance data sources, governmental data sources, and financial institutions. These reference sources may store data that is considered verified or validated, although this data may be static or relatively static (e.g., tax information, credit history, legal history, driving record, previous sale data, payment history, etc.).

The data sources may advantageously also include a plurality of sensors, which may provide more recent, current, updated, precise, nuanced, and/or real-time data associated with the object/subject (e.g., as distinct from more persistent data from the reference sources). The sensors may be vehicle sensors, device sensors (e.g., sensors within a user computing device operated by a user), home sensors, sensors within smart devices (e.g., “internet of things” devices), and the like. Sensors may additionally or alternatively include mobile device sensors (e.g., GPS, speakers, microphone), smart home device sensors (e.g., AMAZON ALEXA, GOOGLE HOME, NEST devices, and RING devices), and wearable device sensors (e.g., FITBIT, APPLE WATCH, PIXEL WATCH). Sensors may also include smart infrastructure sensors (e.g., streetlight, street, and traffic sensors) and/or smart building sensors (e.g., building cameras, building entrance/exit sensors, and utility sensors, such as electricity monitoring (EM) devices).

In some instances, the TM computing device generates a first or initial history for the subject and/or object (generally, “subject history”) based upon the data from the reference sources. The TM computing device may thereafter update or replace the initial subject history with additional data—such as data from the plurality of sensors, updated data from one or more references, or data from any other data sources—to generate an updated subject history. The updated subject history may be referred to as a “real-time” or “current” subject history, in some exemplary embodiments, because this updated subject history may include the most recent available data associated with the subject (e.g., data retrieved and assessed within seconds, minutes, or hours of being sensed or captured). The TM computing device may update the subject history thereafter using any newly received data. In some embodiments, the TM computing device substantially continuously updates the subject history, such as periodically (e.g., daily, weekly, monthly, quarterly, etc.) or in response to receiving new or updated data associated with a subject. Additionally or alternatively, the TM computing device generates the updated subject history in response to a specific request. For example, a user may request an updated subject history because the user is initiating or updating an insurance policy, purchasing an object, selling an object, applying for a job, determining whether to insure a subject, etc.

In the exemplary embodiment, the TM computing device stores the subject history/histories as a container file in an electronic ledger, to securely contain the information. In particular, the TM computing device generates an NFT for the subject based upon the data stored in the container file. The TM computing device allows subsequent access to the NFT by verified or authorized parties-such as a subject themselves, a user associated with the subject and/or authorized by the subject, a user purchasing an object, selling the object, insuring the object, etc. When new or updated information is received and/or incorporated into the container file, the TM computing device generates an updated NFT to represent the updated subject history. The updated NFT may be a completely new token, replacing any pre-existing token (while including a hash value of the previous token) or may be an updated version of the pre-existing token, with a hash including an update log or update history of the container file and/or NFT. In this way, subject histories may be maintained in a current version while being secure, authenticated, and non-modifiable. The NFT may be stored on a blockchain for further security and convenience in storing and distributed processing of the data.

The TM computing device may be further configured to generate an assessment of the subject and/or object (generally, “subject assessment”) based upon the subject history—that is, an initial subject assessment as well as any number of updated (or current, real-time) subject assessments, which may replace or be appended to the initial subject assessment. In the exemplary embodiment, the subject assessment is an objective or quantitative assessment of the subject, such as the subject's reliability (or, in contrast, risk), an object's value, etc., depending upon the particular application of the present disclosure. In some embodiments, the TM computing device may be configured to execute a trained model to generate or calculate the subject assessment. The model may be trained using one or more machine learning, artificial intelligence, and/or cognitive computing techniques, using example, labeled reference and sensor data related to existing subjects/objects as training sets. By incorporating well understood and labeled sensor data into the model training, the resulting output from the model—that is, the subject assessment—reflects a more complete, up to date, and comprehensive assessment and/or valuation of the subject.

In some embodiments, the TM computing device generates the NFT based upon the subject history/histories, and subsequently retrieves the NFT (and the stored container file) to generate the subject assessment. In some embodiments, upon generating the subject assessment using the subject history, the TM computing device may store the subject assessment within a same container file and, thereby, automatically update the NFT based upon the container file. In such cases, the NFT based upon the container file may also include the subject assessment. In further embodiments, the container file and/or NFT may not include the subject assessment, but rather is a pointer to the data that can be readily retrieved for analysis to generate the subject assessment “on-the-fly” whenever a subject assessment is requested.

The TM computing device may update the container file in response to receiving, retrieving, or assessing additional data. The TM computing device may, in some instances, update the subject history based upon the additional data, and update or overwrite the container file. The TM computing device may then re-execute the trained model using the updated container file. Where the model outputs a different subject assessment than a subject assessment already stored in the container file, the TM computing device may update the subject assessment, which may include over-writing or otherwise replacing any pre-existing subject assessment with the new model output, or appending the new model output to the pre-existing subject assessment (e.g., as a new or most recent value in an array). In some embodiments, this updating may include generating a new (updated) NFT.

The NFT may therefore permit continuous, secured, and verified access to a subject's history/histories and assessment(s). Moreover, the NFT remains associated with the related subject or object regardless of any change in status or ownership thereof. That is, the NFT includes persistent information associated with a subject that is object-agnostic (e.g., associated only with the behavior/usage performed by the subject) or an object that is owner-agnostic. However, the NFT is also updated (by the TM computing device using the processes described herein) to reflect any changes in status of the subject. More particularly, the NFT will record any such status or ownership change.

In some instances, where an object is being insured, the object's history with any previous owner(s) is recorded and reflected in the existing NFT, but the TM computing device may import and process data associated with a new or current owner to update the object's history and/or assessment. For example, a person is interested in purchasing and/or insuring a new vehicle or home. While that person's history may not affect the previous object assessment, factors associated with that person (e.g., a driving history, credit history, claim history, etc.) may be incorporated into an updated object assessment, to reflect any potential or likely impact the person's ownership or use may have on the object's value, risk, and/or reliability. In this way, the history or assessment of an object can be “cross-subject”—that is, the history or assessment reflects usage of the object by multiple persons (subjects).

In another instance, where a person is being insured or is seeking coverage of an object, the person's history with previous objects is recorded and reflected in an NFT associated with that person, even when the person's object(s), such as their home/domicile or vehicle, changes. For example, a person's driving behavior may persist across vehicles they own or use. In this way, the history or assessment of the subject can be “cross-object”—that is, the history or assessment reflects usage of various objects or behavior across time/objects by a same subject.

As described further herein, these subject assessments may be applied to users and/or their related object(s) that are operating within a gig economy. These entities may be referred to as on-demand platforms, in the present disclosure. For instance, transportation network companies (TNCs, such as UBER, LYFT), delivery network companies (DNCs, such as UBEREATS, GRUBHUB, DOORDASH), last-mile delivery companies, fleet providers, short-term property rental companies (STRCs, such as AIRBNB, VRBO) may engage the TM computing device to request and receive subject assessments for potential contractors (e.g., drivers, lessors) and/or for potential users of their service (e.g., passengers, lessees). Subject histories and assessments may incorporate data related to a subject across on-demand platforms. Different on-demand platforms may apply different models to generate assessments, such as models in which different characteristics or conditions are weighed differently. As described herein, the different models may be accessible by the NFT (e.g., using a pointer) or may be part of the NFT, so the model may be executed in combination with an NFT (or data therefrom) to produce an output.

In various embodiments, an object assessment or subject assessment may be referred to as a “reliability score” or “risk score.” In certain embodiments, the reliability score or risk score may be directed to a vehicle, a home, or personal articles, such as antiques, or to a behavior of a person or person(s) (e.g., driving behavior, behavior within a home as it relates to risk, travel behavior as it relates to risk, etc.).

The subject/object assessments described herein may be more accurate, precise, comprehensive, and current than other assessments or scores. Specifically, these assessments incorporate data from various sources including current or substantially real-time data, in contrast with one-time, stagnant assessments. Therefore, these subject assessments may facilitate increased user confidence (e.g., in buying, selling, or insuring objects; in insuring users or their objects/property; in lending to a person(s); in hiring a person for a role; etc.), as well as improved process speeds and efficiency, by incorporating the quantitative and automatically generated subject assessments described herein. The disclosed systems and methods employ a collective of data points from smart devices, technology, Internet of Things/Behaviors devices and appliances, as well as evidence from numerous reports generated for home/buildings, vehicles, and other objects, user behaviors, etc.

Moreover, advanced technology (e.g., cognitive computing, AI, and ML) is executed to generate and train models that output assessments, scores, or ratings that are easy to understand, in particular regarding relative insurance risk, to inform a decision about the reliability of a home or vehicle investment, or to inform a decision regarding other types of risk (e.g., relative to lending to a person, selling an object to or buying an object from a person, insuring a household including a person(s), hiring a person, etc.).

The TM computing device implements the methods described herein to “connect the dots” about the use, maintenance, and other history of objects (e.g., real property) as well as behaviors and usage profiles or patterns of people, with real, objective, verifiable evidence (including data from reference sources as well as sensors). The gathering of all these data points and scores (including the reliability scores and risk scores, as well as the sensor data (e.g., smart vehicle sensor data, mobile device sensor data, smart home sensor data) detailed above), and storing them with an NFT in an electronic ledger (e.g., a blockchain) enables adding new reports to the NFT in real time (e.g., as a new hash on the blockchain specific to one unique property such as a car or home or to one subject/user or household/defined groups of subjects/users).

Notably, the NFTs described herein may be formatted and stored as a unique data structure, which stores standardized, secured (e.g., encrypted) data about an object (e.g., a house, vehicle, etc.) and/or a subject (e.g., a homeowner, property occupant, tenant, vehicle owner, vehicle user, ride share driver or occupant, lessor, lessee, etc.), the cross-object ownership/usage history associated with a subject, and/or the cross-subject ownership/usage history of an object, in a readily retrievable format that enhances the efficiency, security, and reliability of subject and object assessment systems. For instance, a subject assessment may be requested and generated substantially in real-time, by accessing and processing a subject history stored within an NFT (and/or identified within an NFT). In some instances, the NFT also stores the subject assessments, and/or other reports or records associated with an object and/or subject, for secure access by authorized parties without requiring any intermediate entity.

The systems and methods described herein may include certain opt-in requirements in order for parties to participate within the system. For example, a user using the user computing device to communicate with the TM computing device may register or enroll as a participating user in the system and may agree to share their data across resources and with other third parties also participating in the system. In addition, as part of registering with the system, a user may be given the option to opt-in to the system for using certain tools and/or sharing certain information with certain parties, and not sharing certain information with other parties. Registration with the system may include acceptance of certain service terms, preferred contact information (e.g., email, SMS text notification, push notification, notification via a digital wallet service, etc.) and preferences for service notifications and the like, or other desired information relating to the user and resources being provided. In other embodiments, the system may anonymize or encrypt confidential or personal data so that such data is further protected.

In some embodiments, the systems and methods described herein may be used for generating and maintaining one or more subject rating models, which may be applied as part of the subject assessment process. The TM computing device may generate and maintain subject rating models in relation to different parties. For example, in some embodiments, one or more subject rating models may be associated with a first on-demand platform, such as a first TNC. One or more different subject rating models may be associated with a second on-demand platform, such as a second TNC or another entity requesting subject assessments.

In the context of the present disclosure, an on-demand platform includes a system allowing individuals to drive people and/or products, lease/rent objects, and/or provide or accept additional/alternative services on demand. For example, an on-demand platform including a TNC is related to the gig economy and allows drivers to join the TNC to provide services, such as driving and food delivery, on-demand through TNC computer applications, which are accessible to both the driver user and the passenger user (or “ordering” user). In these embodiments, the TNC may allow customers to rate the drivers based upon their performance. In some cases, the TNC may allow drivers to rate their passengers or ordering users.

While the below is described in view of on-demand platforms and related “gig work” or other participation in the gig economy, one having skill in the art would understand that the systems and methods described herein may also be used for any individual or group of individuals for whom subject assessments may be requested. For example, this disclosure relates to other types of gig work than driving (temporary or freelance work performed by an independent contractor on an informal or on-demand basis), vehicle operators within fleets, and/or non-work-based groups of individuals.

In one exemplary embodiment, the subject rating models may be associated with contracted terms, such as for insurance for a driver while working for a TNC. For example, the contracted term for the driver may be for one year, or only while the driver is operating on behalf of that TNC. The TM computing device may input data related to these subjects into a subject rating model, to provide a baseline rating or assessment of their behavior, which can subsequently be employed to provide recommendations to improve the behavior or rewards for above-standard behavior. Continuing with the example of the driver of the TNC, a subject rating model may be applied to data relating to the driver's behavior while operating a vehicle, but only while operating on behalf of that TNC. The person's driving behavior may be assessed for a baseline value or rating, and recommendations or rewards may be provided based upon the baseline value or rating. Improved driving behavior over time may potentially reduce the cost of vehicle insurance for professional and/or personal driving. Subject ratings or assessments may also be used, for example, by on-demand platforms to assign or push tasks to one operator over another (e.g., to prioritize work from a safe driver vs. a risky driver). Another example may include applying the subject rating model to generate an assessment of lessor behavior or lessee behavior, in the case of STRCs or vehicle rental platforms (e.g., TURO). Recommendations to reduce risky behavior (or other behavior that may be disfavored) may be generated in response to lower ratings.

In some embodiments, a single subject rating model may be applied across similar on-demand platforms. That is, data for a person operating across more than one on-demand platform of a same type may all be applied to a sample subject rating model. For example, data for a driver across their operation for UBER and for LYFT may all be assessed using a first subject rating model. Alternatively, different on-demand platforms may engage the TM computing device to generate and maintain different rating models. In these cases, the TM computing device may generate models that weight data differently, or models that only use data associated with a single related on-demand platform.

In one exemplary embodiment, the TM computing device may receive data associated with an individual and/or a group of individuals, such as, for example, a group of drivers at a TNC or a group of fleet drivers within a same fleet. Such data may include, for example but without limitation, data from previous vehicle insurance claims and previous insurance history for the corresponding individual and/or any vehicles associated with that individual. The previous vehicle insurance claims and previous insurance history may be for multiple vehicles all associated with the same individual. Furthermore, the previous vehicle insurance claims and previous insurance history may also include information about other individuals that may be associated with the same vehicles, such as family members and/or roommates that may also operate the vehicle. The received information may further include data from vehicle maintenance and repair reports (e.g., inspection records, maintenance/service records, etc.), vehicle valuation data, and tax histories. In some further embodiments, the received plurality of data may also include motor vehicle records and/or property records related to the object. As described herein, these subject histories can be cross-object. For example, if a person received a speeding ticket in one vehicle, that record may apply to the subject regardless of which vehicle that person operates at other times.

The received information may also include behavior data from vehicle sensors including, but not limited to, driving behavior and other telematics applications associated with the vehicle(s) associated with the corresponding individuals. The driving behavior data may include, but is not limited to, telematic data provided by sensors in the vehicle. This telematics data may be provided directly from the vehicle, from one or more mobile computer devices in communication with the vehicle, from the manufacturer of the vehicle, and/or from one or more devices connected to the vehicle (such as provided by an insurance company).

In some embodiments, data captured by these sensors may be authenticated or validated before being accessed by the TM computing device to generate subject assessments. For example, a subject user may be required to authenticate themselves using a biometric sample (e.g., a fingerprint, iris scan, face scan, voice signal, etc.) before data will be collected by the vehicle sensor and associated with that subject's behavior, or before any collected data will be stored.

The received information additionally may include driver evaluation criteria from a third-party system or computer application, such as that provided by a TNC. This driver evaluation criteria may include one or more ratings of the driver. At least one of the ratings of the driver may be based upon feedback provided by users of the TNC computer application, where the driver provided driving and/or delivery services for those users. For example, after a ride with a ride-sharing application, most applications allow the rider to provide a rating of the driver (e.g., from one star to five stars) based upon how the ride was, how good of a driver the individual was, and/or how safe the rider felt during the ride. The driver evaluation criteria may also contain information about the performance of the driver in their duties with the TNC. This performance information may include, but is not limited to, percentage/number of attempted tasks, percentage/number of completed tasks, average time to complete tasks, average time to complete tasks compared to average expected completion time, etc.

It should be understood that where a subject rating model is being applied in relation to a subject other than a driver, the received data associated with the subject may be other than driving-related information. For instance, home telematics data, calendar data, passenger data, etc. may be received or retrieved.

In some embodiments, the TM computing device may store this data related to the subject—including subject behavior—as a subject history. Specifically, as described herein, the TM computing device may store such a subject history as a container file in an electronic ledge (e.g., a blockchain). The TM computing device may generate an NFT based upon the data stored in the container file. As explained herein, this NFT may be associated with a particular individual and may include cross-object data. For example, an NFT may be unique to a driver operating on behalf of one or more TNCs. The TM computing device may generate the NFT to include different subject histories or related data in different partitioned sections. One section may include a personal driving history, another section may include a driving history related to operation on behalf of a first TNC (e.g., UBER), and another section may include a driving history related to operation on behalf of a second TNC (e.g., LYFT). In this way, the TM computing device may restrict access to certain data related to the subject. For instance, if the first TNC wishes to generate a subject assessment for the driver, the TM computing device may restrict access to only the driving history related to operation on behalf of that first TNC, or may grant access to that data as well as the personal driving history (e.g., depending on permission from the user).

The TM computing device may be configured to access one or more subject histories from the NFT to apply that data to a subject rating model (and, thereby, generate a subject assessment). The TM computing device may additionally or alternatively provide subsequent access to the NFT by verified or authorized parties, including, in these examples, on-demand platforms.

In the exemplary embodiment, the TM computing device includes or stores the subject rating models as one or more machine learning (ML) trained models and/or one or more trained artificial intelligence (AI) systems. Specifically, the TM computing device may train and store the models/systems using known and labeled data, such as historical reference data for one or more subjects. The TM computing device executes the AI/models to perform one or more overlays against the previous or current models to compare, learn, and apply. The one or more overlays may be used to determine if adjustments and/or updates are needed to one or more current models to continue to evolve those models.

In some embodiments, the TM computing device may apply the (trained) subject rating models to one or more subject histories, to analyze the data therein and generate an output including a subject rating or assessment. For example, with respect to a subject rating requested by a TNC, the TM computing device may apply the subject rating model to analyze the data for each driver to determine how good or bad of a driver they are. For example, how does the driver's experience as a professional driver through the TNC change or affect their personal driving? In some situations, the driver's experience as a professional driver may improve their personal driving. In other situations, the driver's personal driving may be worse after a day of driving others. In many cases, TNC drivers are rated by their passengers and may take more care to preserve their good ratings.

Additionally, the TM computing device may receive relevant data from approved sources and, prior to or after executing the subject rating models, evaluate any gaps that require more documentation or data. If such a deficiency in the data is identified, the TM computing device may make requests for any missing data points. The TM computing device may transmit requests for any detected missing data points to one or more of the third-party servers and/or one or more client computing devices.

In one exemplary embodiment, the TM computing device may apply the subject rating models to securely stored subject data (e.g., within an NFT) to generate insurance pricing for individuals and effective group ratings. In some embodiments, the ratings may include mutual, standard, and substandard ratings, where those rated mutual are highly desirable customers.

In one exemplary embodiment, the TM computing device may apply the subject rating model to output real-time recommendations that are designed objectively improve ratings (and, in some embodiments, insurance pricing). For example, the system may be employed and configured to analyze the drivers operating on behalf of a TNC. For the TNC, the group of drivers are collectively rated. The output of real-time recommendations may be configured to reduce the risk associated with the group of drivers. For example, the TM computing device may determine which drivers are rated better than others and would therefore be lower risk than other drivers. These lower-risk drivers may be identified to the TNC to inform the TNC that these drivers are associated with lower premiums, while other higher-risk drivers are associated with higher premiums. The TNC may use this risk and rating information to adjust the list of drivers that it selects for tasks. The TNC may also inform the higher-risk drivers to adjust their driving to lower their costs. The TNC may also share the cost savings of lower premiums with the lower-risk drivers.

In one embodiment, the TM computing device may be configured to use the outputs from the subject rating models to automatically generate subject assessments that include rating, pricing, and recommendations for individuals and/or groups. The rating, pricing, and recommendations may be provided to the subject users, such as drivers, to show how they are performing (e.g., as related to “risky” behaviors) and how they may improve. The rating, pricing, and recommendations may include steps that a subject user may take to improve their ratings. In some embodiments, improvements may be tied to bonuses or other rewards. As one example, as a driver's ratings improve, the cost of insurance for them may go down. In some embodiments, a portion of this cost reduction may be shared with the driver (and/or other drivers within a group). In some of these embodiments, the TM computing device may generate lists or groups of drivers that are in the same risk or rating categories. For example, the TM computing device may generate a list of drivers associated with a TNC that are in the mutual category, a list of those in the standard category, and a list of those in the substandard category. The TM computing device may use other categories in relation to different on-demand platforms or other third-party entities.

In one embodiment, the TM computing device may provide individuals with their rating and pricing for insurance and may further connect them with an agent for processing of a policy with the rating and pricing. For example, a driver that is covered under a blanket insurance from a TNC when the driver is working for the TNC and has a good rating and/or low risk may be approached for personal insurance with offers based upon their rating/risk.

In some further embodiments, the TM computing device may execute the subject rating models to determine behavior patterns indicative of defined groups of people, such as driving patterns indicative of drivers for TNC applications. Accordingly, the TM computing device may be able to determine which drivers are working for TNC applications and when, based on their driving behavior compared to other drivers and/or their own behavior at different times. In some embodiments, the TM computing device may identify drivers that are working for a TNC application and are considered good drivers. The TM computing device may transmit information about those identified drivers to agents and reach out to the identified drivers with pricing for insurance for those drivers.

In some further embodiments, the systems and methods described herein may be used for generating and maintaining one or more dynamic subject rating models, which may be applied as part of the subject assessment process. The TM computing device may generate and maintain dynamic subject rating models (referred to herein as “dynamic rating models”) in relation to different parties. For example, in some embodiments, one or more dynamic rating models may be associated with a first on-demand platform, such as a first TNC. One or more different dynamic rating models may be associated with a second on-demand platform, such as a second TNC or another entity requesting subject assessments.

The dynamic rating models described herein are configured to provide real-time assessment or rating of a subject user and, in some embodiments, information that may impact the behavior of the subject. For example, real-time recommendations may be provided that could help a driver for a TNC earn more money, carn a reward, or carn a different level of status while driving that day. Some of the information determined by the dynamic rating model may include determining when the driver may be more aggressive, safer, more or less observant, more or less reactive, and/or other attributes. Furthermore, the dynamic rating models may be used to determine what happens when a driver receives one or more recommendations from the system and ignores those recommendations or otherwise does not change their behavior.

In one embodiment, the dynamic rating process is configured to help to evaluate drivers accurately and potentially from different perspectives to determine ratings for those drivers and, for TNC applications, determine risks and insurance costs for those drivers. For example, if 90% of the drivers for a TNC are high-risk, then the TNC may need to re-evaluate its driver recruiting methodology to reduce its insurance costs. Furthermore, the dynamic process may provide recommendations to improve the ratings and/or risks associated with each driver, while providing those recommendations to the drivers in real-time. For example, the dynamic process may inform a driver that they are entering a lower speed zone, such as a school zone. The would be helpful, especially where the driver is not familiar with the area. Another recommendation may be where the dynamic process determines that the driver is not coming to a complete stop at stop signs and the dynamic process recommends counting to two or another method of ensuring that the driver comes to a complete stop.

In other embodiments, the dynamic rating process allows for regular updates to pricing for insurance for the individuals and/or groups. In one embodiment, the dynamic process may analyze the last few months of data about the driving behavior of the driver and use that to determine a price of insurance for the next month. The dynamic process may also provide driving recommendations to improve the price for the following month and/or provide encouragement/congratulations for achieving improvement and reduced insurance costs.

In one embodiment, to initiate the dynamic rating process, the TM computing device may receive data associated with an individual and/or a group of individuals, such as, for example, a group of drivers at a TNC. These various data are described above in greater detail.

In the exemplary embodiment, the TM computing device includes or stores the dynamic rating models as one or more machine learning (ML) trained models and/or one or more trained artificial intelligence (AI) systems. Specifically, the TM computing device may train and store the models/systems using known and labeled data, such as historical reference data for one or more subjects. The TM computing device executes the AI/models to perform one or more overlays against the previous or current models to compare, learn, and apply. The one or more overlays may be used to determine if adjustments and/or updates are needed to one or more current models to continue to evolve those models.

In some embodiments, the TM computing device may apply the (trained) dynamic rating models to one or more subject histories, to analyze the data therein and generate an output including a subject rating or assessment. For example, with respect to a subject rating requested by a TNC, the TM computing device may apply the dynamic rating model to analyze data for each driver to determine how good or bad of a driver they are, in particular, in real time. For example, how does the driver's experience as a professional driver through the TNC change or affect their personal driving? In some situations, the driver's experience as a professional driver may improve their personal driving. In other situations, the driver's personal driving may be worse after a day of driving others. In many cases, TNC drivers are rated by their passengers and may take more care to preserve their good ratings.

In the exemplary embodiment, the TM computing device may retrieve relevant data from approved sources and evaluate any changes that impact previous ratings and risk modeling. For example, if a driver received a speeding ticket or has been driving differently since the last time that their information was analyzed, the TM computing device may recommend adjustment of the rates and/or premiums of the insurance for that driver.

In some embodiments, the TM computing device analyzes neighborhood and route risk data including recommendation compliance. Recommendation compliance may include determining whether or not the user followed recommendations from the TM computing device and/or the TNC application. For example, the driver picks up a passenger at a specific place, and the TNC application provides a route to take the passenger on to reach their destination. The TNC application may provide what is calculated to be the saftest route, such as the route with the least risk. However, the driver may decide to take a different route, such as a more scenic route. The TM computing device may analyze that deviation from the provided route and determine whether that deviation represents more or less risky behavior.

The TM computing device may generate risk, rate, and insurance pricing for individuals and effective group ratings. In some embodiments, the ratings may include mutual, standard, and substandard ratings, where those rated mutual are highly desirable customers. In some embodiments, the TM computing device detects adjustments to the driver's performance throughout the day/shift. These adjustments are compared to changing conditions in and/or around the vehicle, such as, but not limited to, number of passengers, number of packages, transporting people or items, category of service, time spent working, time since last break, time of day, current traffic conditions, safety or riskiness of roads taken, etc. The TM computing device determines how these different factors affects the performance of the driver. For example, a driver may perform well for the first three hours of a shift of driving, but then start making more mistakes or becoming a riskier driver in the fourth hour. The TM computing device and/or the TNC application may transmit one or more recommendations to the driver to take a break, maybe get some food and/or rest. The TM computing device may analyze data to determine which factors may positively and/or negatively affect driver performance and overall riskiness and may provide recommendations to drivers to improve their driving and reduce their risk.

In one embodiment, the TM computing device analyzes data from connected vehicles/applications, such as, but not limited to, vehicle weight from the start of shift to the end of shift. The data includes information about weight, if currently operating, number of passengers (e.g., from number of seatbelts fastened), number of packages in the vehicle, etc.

The TM computing device uses this information to determine risk profiles that may change over time, at different times of day, days of week, etc. In some embodiments, insurance coverage for the driver and/or vehicle may also change over time as the risk profile changes. For example, a vehicle may be shared with multiple individuals, such as multiple households. The coverage on the vehicle may change based on whether or not the current driver is the owner of the vehicle or someone who is borrowing the vehicle. This sharing system may be connected to a calendar application showing who is to use the vehicle when.

In one exemplary embodiment, the TM computing device may be consistently performing steps of the dynamic rating process for some or all of the drivers being analyzed. In some embodiments, the TM computing device only analyzes drivers when they are actively driving or working for the TNC application. In other embodiments, the TM computing device analyzes each driver on a periodic basis.

In the exemplary embodiment, the TM computing device outputs real-time behavioral recommendations to objectively improve rating and pricing for use based on individuals and groups of individuals. Additionally, in some embodiments, the TM computing device may also output automated rating, pricing, and recommendations for individuals and groups. The rating, pricing, and recommendations may be provided to the drivers to show how they are performing and how they may improve. The rating, pricing, and recommendations may include steps that a driver may take to improve their ratings. In some embodiments, improvements may be tied to bonuses or other rewards. In some of these embodiments, the TM computing device generates lists or groups of drivers that are in the same risk or rating categories. For example, the TM computing device may generate a list of the drivers associated with a TNC that are in the mutual category, a list of those in the standard category, and a list of those in the substandard category. The TM computing device may assign other categories as desired.

In some embodiments, the TM computing device is in communication with one or more third-party servers, or one or more sensors associated with a vehicle manufacturer of a vehicle being operated by a driver. The vehicle manufacturer third-party server or sensors may provide information about the vehicle, such as, but not limited to, weight, if currently operating, number of passengers (e.g., from number of seatbelts fastened), number of packages in the vehicle, etc. The TM computing device may then calculate real-time scalable coverage based on the current risk and value of the vehicle. For example, a delivery vehicle may be more valuable and require more coverage when it is fully loaded with packages rather than when it is mostly empty. Or if a vehicle is shared with other members of the neighborhood. These situations and others illustrate different exposures based upon number of people in the vehicle, current location, current driving behavior, time of day, etc.

In the exemplary embodiment, the TM computing device may be configured to store any output(s) from the subject/dynamic rating models as container files for storage within one or more NFTs. The TM computing device may, in some embodiments, only store a rating or assessment output from the model. The TM computing device may additionally store any other evaluations or outputs, such as recommendations, rewards, and the like.

In some embodiments, the TM computing device may update one or more container files in response to receiving, retrieving, or assessing additional data. The TM computing device may, in some instances, update a subject history based upon additional data, and update or overwrite the container file. The TM computing device may then re-execute the subject/dynamic rating model using the updated container file.

Where the subject/dynamic rating model outputs a different rating or assessment than the subject assessment stored in a container file, the TM computing device may update the subject assessment, which may include over-writing or otherwise replacing any pre-existing subject assessment with the new model output, or appending the new model output to the pre-existing subject assessment (e.g., as a new or most recent value in an array).

The gathering of all these data points and ratings (including the reliability scores and risk scores, as well as the sensor data (e.g., smart vehicle sensor data, mobile device sensor data, smart home sensor data) detailed above), and storing them with an NFT in an electronic ledger (e.g., a blockchain) enables adding new reports to the NFT in real time (e.g., as a new hash on the blockchain specific to one unique property such as a car or home or to one subject/user or household/defined groups of subjects/users). Notably, the NFTs described herein may be formatted and stored as a unique data structure, which stores standardized, secured (e.g., encrypted) data about a subject user related to their involvement with an on-demand platform (e.g., a homeowner, property occupant, tenant, vehicle owner, vehicle user, ride share driver or occupant, etc.), in a readily retrievable format that enhances the efficiency, security, and reliability of subject assessment systems.

A brief discussion of examples and use cases follows herein. It should be readily understood that these examples and use cases are illustrative and should not be taken to limit the present disclosure.

Examples of data that may incorporated into an object history and/or object assessment may include, but is not limited to: physical inspections, repair/maintenance history, external reports (e.g., police reports), purchase/sale history, permit history, claim history, tax history, location-related data (e.g., location risk data), and sensor data. As described herein, sensor data includes, but is not limited to, data from sensors in vehicles, user computing devices, homes/buildings, smart devices, smart materials, and “internet of things” devices and appliances, including smart thermostats that may sense temperature, humidity, and heating/cooling data. Sensor data may, in many cases, reflect the behavior and routines of one or more user(s) associated with an object. In the exemplary embodiment, one or more users associated with an object may provide permission or consent to the TM computing device to retrieve/receive/process certain data and may revoke or change permissions for various data sources.

With respect to vehicles, if a young or unreliable driver repeatedly races a vehicle, but the vehicle remains looking pristine on the surface, the TM computing device may determine—based upon sensor data from the vehicle—that the engine and transmission has been used in a manner that could cause a shortened vehicle life span. The resulting object assessment may therefore reflect a higher risk, lower reliability, or lower value for the vehicle. Certain factors (e.g., sensor data) that may be assessed include acceleration data, braking data, cornering data, mileage, tire condition, maintenance or repair histories, vehicle part status, recall history or status, and the like.

With respect to buildings, a lack of maintenance records or permits, or data about home health, humidity, heating, cooling, and insurance claims could suggest a lower value, lower reliability, and/or higher risk for a building, which may be reflected in the resulting object assessment(s). For example, “DIY” repairs, keeping a home at an undesirable temperature or humidity, repeated insurance claims, and/or buildings in high-risk locations may each be reflected in the object assessment(s). In contrast, records reflecting proper permitting for projects, the use of improved materials, and the like, could reflect more positively in the object assessment(s). Certain factors that may be assessed include inspection data, building materials, geographic location, addition/modification history, neighborhood risk factors, temperature data, humidity data, water data (e.g., sensed leaks), and insurance claims history.

A person's behavioral history, as represented by sensor data captured over time as well as certain records (e.g., credit records, financial records, legal records, etc.) may be aggregated and analyzed as part of their subject history and/or subject assessment. For example, driving behaviors may be included, such as acceleration data, braking data, cornering data, location data, routes, times of travel, and the like. In some instance, other travelling behaviors may be included to assess a person's behavior and relative risk, such as when the person is a passenger in vehicles or is travelling using a bike or scooter or as a pedestrian. Other behaviors may also be analyzed to assess a person's relative risk, like their behaviors at home that can be sensed using smart home, IoT, or home security devices, for example. For instance, a person's behavior related to leaving doors/windows locked or unlocked, leaving appliances on when not in use, smoke detector records, time at home vs. time away from home, and the like, can be representative of a person's behavior.

As discussed herein, an object's history/assessment can be cross-subject. For example, where a vehicle is a family vehicle used by several members of a household, each person's driving behavior in the vehicle may contribute to the vehicle's history/assessment. As another example, the history and/or assessment of a home or apartment with several occupants may be influenced by the behavior of all such occupants. Additionally, a subject's history and assessment can be cross-object. For example, a person's driving behavior across two or more vehicles can all contribute to that person's subject history/assessment. Similarly, the person's behavior while living at different addresses and/or while travelling can all contribute to the person's subject history/assessment.

In some exemplary embodiments, the TM computing device is programmed to weight behaviors or other factors differently. For example, behaviors may become “de-weighted” over time—such that a teenager whose driving behavior improves over time may have their subject assessment adjusted over time, as carly driving behaviors impact their assessment less. As another example, a person who moves or changes jobs may drive or commute at less risky times or in less risky environments. In such a case, the risk level of their previous behavior becomes less impactful over time, relative to their subject assessment. The passage of time may be applied as a type of decay factor in the generation of assessments. Additionally or alternatively, major events may have a more drastic impact on the weighting of previous behaviors, such as moving, changing jobs, marriage, divorce, new children, children leaving a household, major illness, etc.

As described herein, for at least data security and transportability purposes, the TM computing device may “package” the subject histories and assessments as NFTs. In some examples, an NFT records a subject/object history and/or assessment relative to a single subject or object, which may be identified with a unique subject or object identifier, as described herein. In some additional embodiments, the TM computing device may be further programmed to generate NFTs that aggregate cross-subject object histories/assessments, cross-object subject histories/assessments, multiple subject histories/assessments, and/or multiple object histories/assessments, according to other rules that enable such grouping within a single NFT, referred to generally as a supertoken. For example, the TM computing device may be programmed to generate a supertoken representative of one household, which can include an aggregation of or pointers to individual NFTs for multiple household subjects, including occupants, the home/property, one or more vehicles, and/or other insured objects. As another example, the TM computing device may be programmed to generate a supertoken for a single vehicle that incorporates or points to the subject assessments of multiple drivers that use that vehicle as well as an NFT of the vehicle history itself. In such embodiments, the TM computing device may be further programmed to disaggregate such supertokens as required or requested. For example, where a child leaves a household, the TM computing device may be programmed to remove a subject assessment (or a pointer thereto) from a supertoken associated with that household or a vehicle used by members of the household.

In some embodiments, the TM computing device may transmit subject histories, subject assessments, object histories, object assessments, container files, and/or associated NFTs to (verified or validated) requesting parties. For example, the TM computing device may transmit an NFT for an object to an insurance underwriter, which enables the underwriter to access the object assessment. Insurance underwriting models and pricing can be developed and used based upon these subjects and/or object assessments. Moreover, as subject histories and assessments are updated, this information can be processed and analyzed (e.g., by the TM computing device) to identify trends across like subjects, like objects, like locations, etc.

It should be understood that references to insurance products and policies herein are non-limiting references. In particular, policies may be issued for specific objects or groups thereof (e.g., one vehicle or a group/fleet of vehicles) and/or for specific individuals or groups thereof (e.g., policies covering a person and/or their partner(s), dependent(s), and/or household). That is, policies may be object-or subject-centered. In some instances, policies or other insurance products mat include usage-based insurance (UBI). UBI, as used herein, may refer generally to insurance policies based upon a user's particular usage or performance of one or more covered behaviors. For example, a usage-based policy associated with a user's travel may have certain charges or premiums associated with various types of travel (e.g., personal auto travel, public transportation, ride-sharing, biking, etc.). The cost of the policy may depend on how much the user uses each of those types of travel within a given time period (e.g., per month, per year, etc.).

“Personal mobility (PM) insurance” or “personal mobility policy (PMP),” as used herein, may refer generally to insurance policies based upon a user's usage of various forms of transportation. As increasingly more personal mobility options (e.g., modes of transportation) become available, users have more options to choose from when it comes to travel. Personal mobility insurance may provide coverage when a user is a pedestrian, a passenger of a ride-sharing service, and/or a driver of a rental vehicle, a semi-autonomous vehicle, and/or an autonomous vehicle. In other cases, personal mobility insurance may provide a user with coverage when the user rides a bike or an electric scooter. Personal mobility insurance further provides coverage in cases where a user may not own a vehicle and/or not drive. For example, the user may travel from place to place by using various alternative forms of transportation, including walking, biking, using public transportation, and/or using ride-sharing services. In these cases, personal mobility insurance may offer coverage if the user is injured as (i) a ride-share service passenger due to the driver's negligence or fault, (ii) a pedestrian getting into or out of a ride-share vehicle, and/or (iii) a bike or electric scooter rider due to being injured by an uninsured motorist.

Additionally, the present embodiments may relate to micro-mobility or micro mobility trends. For instance, the PMP or other insurance policies may cover micro-mobility forms of transformation and/or provide micro-mobility coverage on demand. The present embodiments may provide micro-mobility coverage or micro-mobility insurance for short distance travel—such as the first mile of a trip (such as to reach or travel to a public transportation or a ride share pick-up point), or the last mile of the trip (such as to reach or travel to a final destination, such as via e-scooter or bike). In some embodiments, the micro-mobility coverage or insurance may be in the form of UBI. UBI micro-mobility coverage may be sold by time or mileages, or other units (e.g., rides, trips), for instance. In one embodiment, the micro-mobility coverage may cover modes of transportation and/or vehicles with speeds less than 20 mph, carry 1 or 2 people, and associated with trips of short distances (such as a 1 or 2 miles).

“On-demand insurance,” as used herein, may refer generally to providing PMP (personal mobility policy) and/or micro-mobility UBI (usage-based insurance) quotes to a user in real time when coverage is requested by a user. On-demand insurance may provide coverage on a pay-as-you-go basis for each trip taken by the user (e.g., insurance provided on a trip-by-trip basis), as opposed to paying for coverage for a standard period of time (e.g., six months). For example, coverage may be requested or purchased for certain trips a user plans to take. PMP and/or micro-mobility insurance may be offered in various units, such as miles, time units, or rides. Micro-mobility insurance may cover short trips, such as the first mile and/or the last mile to a destination. For instance, the first mile and/or last mile to a destination may include users traveling by alternate forms of transportation, such as public transportation, ride shares, bicycles, or e-scooters.

In the exemplary embodiment, the TM computing device securely stores subject histories and assessments in container files that are accessible via cloud-based networks and devices, for improved accessibility.

As used herein, an NFT (non-fungible token) is a digital asset that represents another object, such as, but not limited to, a real-world object and/or a digital object. The NFT may be generally stored in a blockchain or other cryptographic ledger or register. The NFT may include, but is not limited to, ownership information and a link to a digital asset file that describes, points to, or otherwise indicates a real-world or digital object (or in some cases the NFT may actually include the data associated with the digital asset or real-world asset). NFTs may be traded, sold, exchanged, or otherwise change ownership. The ownership change may be stored on the corresponding blockchain, ledger, and/or register.

A blockchain is a distributed database that maintains a continuously-growing list of ordered records, known as blocks. Each block may contain at least a timestamp and a link to the previous block in the chain. The link to the previous block may be a hash of the previous block. For an insurance contract, the first block may contain the initial contract between a driver and an insurer. The second block may contain a modification to the contract that was requested by the driver and approved by the insurer. The second block may contain a hashed copy of the first block as well. The third block may contain one or more additional terms for the insurance contract and a hashed copy of the second block. This continues on with each block adding on to the next while containing a hash of the previous blocks in the blockchain.

To ensure the security of the information contained in the blockchain, copies of the blockchain may be distributed across multiple computer devices, known as nodes. These nodes maintain the blockchain, update the blockchain when changes occur, and ensure the stability of the blockchain itself. In some embodiments, nodes may be also used to calculate the hash of the previous blocks. As the blockchain grows, the processing power needed to calculate the hash of the previous blocks grows as well. In these embodiments, the processing of the hash may be distributed over multiple computer devices to improve the speed of processing and/or to not overburden the hashing processor. When a node processes (hashes) a block, that node is known as a miner, where the action of validating and hashing the block is also known as mining.

Other electronic ledger infrastructure may be employed, which may include blockchains or other similar technology. More broadly, the term “container file,” as used herein, may refer to a block in a blockchain, or to any other recorded instance in an immutable electronic ledger.

In at least one embodiment, the NFT entry on the blockchain includes the location of the NFT and a hash of the NFT. This hash allows the TM computing device and/or any users to ensure that the NFT has not been modified. In these embodiments, when data is added to the NFT, then the NFT is re-hashed, and that hash is provided in a new block on the blockchain. For example, the TM computing device may receive updated ownership information from a third-party server, or updated sensor information from a vehicle or user computing device. The TM computing device retrieves the location of the NFT and the hash for the NFT from the blockchain. The TM computing device compares the hash to the NFT to validate the NFT. In at least one embodiment, the TM computing device hashes the NFT and compares that hash to the stored hash. If they match, then the NFT is validated. The TM computing device modifies the NFT to include the report and then creates a hash of the NFT including the report. The new hash is reported to and stored in a new block on the blockchain.

At least one of the technical problems addressed by this system may include: (i) collecting and transforming reference and sensor data to generate subject and/or object histories; (ii) generating an NFT based upon a subject/object's history to improve access security and standardize formatting of the subject/object history; (iii) generating such NFTs as unique data structures that can be encrypted—for increased data security—and subsequently decrypted—for access to the collected and transformed sensor data (e.g., as a standardized subject/object history) by permitted parties; (iv) enabling iteration of these processes with updated data to maintain currency of records; (v) improving speed and efficiency of insurance underwriting and the processing of requests for new or updated policies associated with subjects and/or objects; (vi) improving accuracy and reducing fraud (or buildup) related to object ownership transfer; (vii) ensuring the integrity of data related to an object's history and previous/current assessments; (viii) saving accurate records; (ix) consistently analyzing subject and object histories and assessments to provide consistent results and detect trends; (x) predicting potential issues based on these trends, to recommend mitigating action; (xi) allowing multiple users to interact with the data while preserving the data integrity; (xii) generating recommendations to improve subject/object assessments; (xiii) enabling the creation, storage, access, and use of cross-subject object histories and assessments, cross-objects subject histories and assessments, multiple-object histories and assessments, multiple-subject histories and assessments, and combinations and variations thereof; (xiv) transportable NFTs (including subject histories/assessments) that can be accessed and updated across applications and over time.

The methods and systems described herein may be implemented (i) using computer programming or engineering techniques including computer software, firmware, hardware, or any combination or subset thereof, and/or (ii) by using one or more local or remote processors, transceivers, servers, sensors, servers, scanners, mobile devices, wearables, AR or VR headsets or glasses, smart glasses, and/or other electrical or electronic components, wherein the technical effects may be achieved by performing at least one of the following steps: (i) receiving a plurality of data associated with an object history of an object; (ii) generating a container file for the object history to include the plurality of data; (iii) generating a non-fungible token (NFT) for the object based upon the container file; (iv) storing the NFT and the container file for the object; (v) retrieving the NFT to access the plurality of data; and/or (vi) inputting the plurality of data to a trained model to receive an initial object assessment as output from the trained model.

The technical effects may additionally be achieved by performing at least one of the following steps: (i) receiving a plurality of data associated with a subject history of a subject; (ii) generating a container file for the subject history to include the plurality of data; (iii) generating an NFT for the subject based upon the container file; (iv) storing the NFT and the container file for the subject; (v) retrieving the NFT to access the plurality of data; and/or (vi) inputting the plurality of data to a trained model to receive an initial subject assessment as output from the trained model.

The technical effects may additionally be achieved by performing at least one of the following steps: (i) receiving a plurality of data associated with a history of a subject; (ii) executing at least one model with the plurality of data to generate a subject rating for the subject and a recommendation of at least one recommended action that would improve the subject rating; (iii) generating a non-fungible token (NFT) including one or more of: the plurality of data, the subject rating, or the recommendation; (iv) monitoring actions of the subject to determine if the at least one recommended action was performed; and/or (v) re-executing the at least one model with the plurality of data and updated data based upon the actions of the subject and the at least one recommended action to generate an updated subject rating.

### Exemplary System and Process for NFT Generation and Maintenance

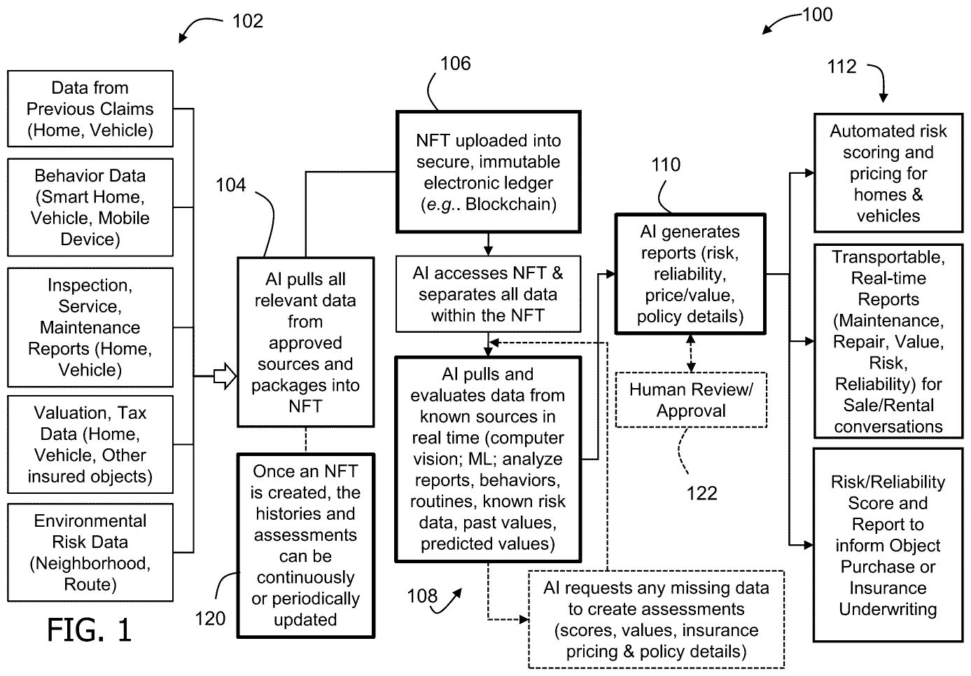

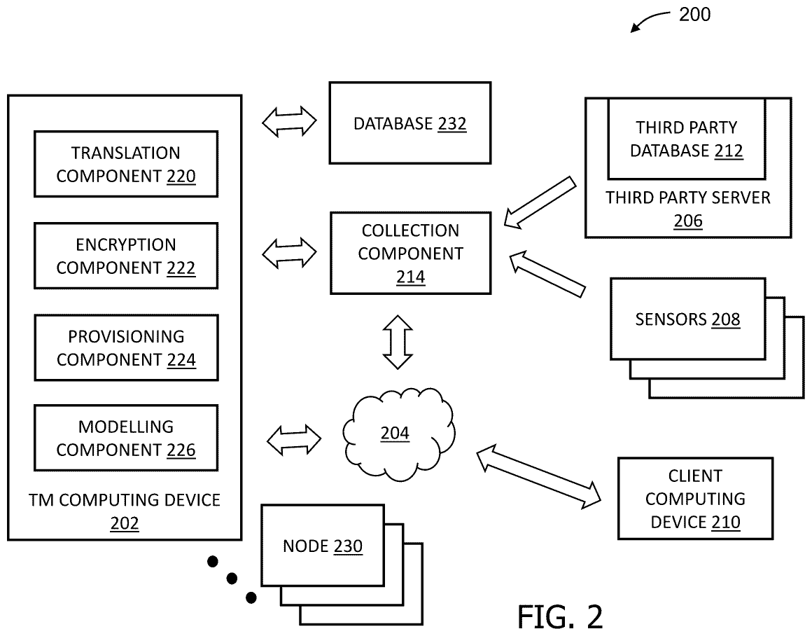

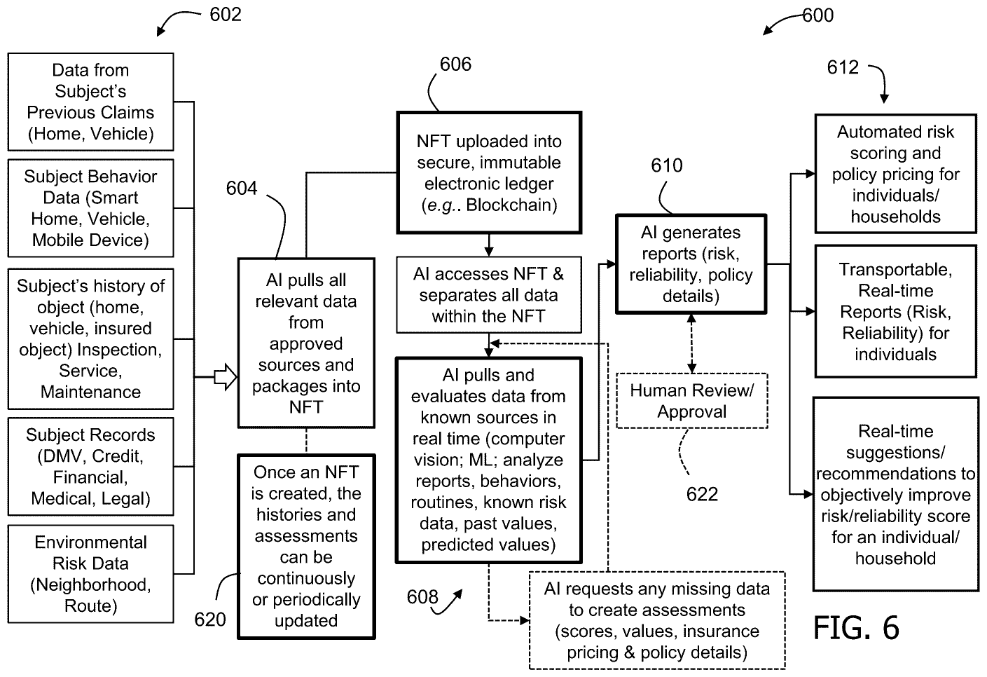

FIG. 1 illustrates a flow chart of an exemplary process 100 for generating and maintaining NFTs related to object histories and assessments in accordance with one embodiment of this disclosure. FIG. 6 illustrates a flow chart of an exemplary process 600 for generating and maintaining NFTs related to subject histories and assessments in accordance with one embodiment of this disclosure. FIG. 2 depicts a simplified block diagram of an exemplary computer system 200 for implementing various processes, including any processes described herein. Concurrent reference to FIGS. 1, 2, and 6 may be made in the following discussions. Moreover, steps or functions that are similar between processes 100 and 600 may be referred to concurrently, using the reference numeral for a step in the process 100 (e.g., 102) and the reference numeral for a step in the process 600 (e.g., 602) simultaneously (e.g., “a step 102, 602”).

System 200 includes a token management (TM) computing device 202, also referred to as a TM server, which may perform one or more steps of processes 100 and 600. In the exemplary embodiment, TM computing device 202 includes one or more computers that include a web browser or a software application, which enables TM computing device(s) 202 to receive data and messages from other devices over a network 204 using the Internet.

In the exemplary embodiment, TM computing device 202 receives 102 a plurality of data associated with an object—more specifically, with an object history of the object. As shown in FIG. 1, such data may include, for example but without limitation, data from previous insurance claims related to the object or by a same or related insured, behavior/sensor data (e.g., from smart home devices, mobile devices, vehicles, etc.), reports associated with the object (e.g., inspection records, maintenance/service records, etc.), valuation and/or tax data associated with the object, and environmental data (e.g., weather data, risk data related to a location of the object, routes travelled using a vehicle, etc.). In some further embodiments, the received plurality of data may also include motor vehicle records and/or property records related to the object.

With respect to FIG. 6, TM computing device receives 602 a plurality of data associated with a subject—more specifically, with a subject history of the subject. As explained herein, where the subject includes an object, the object history may be based upon some or all of the data described above. Where the subject includes a person, the data may additionally or alternatively include, without limitation, data from previous claims made by the subject, behavior data related to the subject, a history of the subject's reports and records related to insured objects, other records of the subject (e.g., governmental records such as driving records, credit records, financial records, legal records, medical records, etc.), and environmental data (e.g., where the subject is located, where the subject travels, risk profiles of the type, location, time of travel, etc.). As described herein, these subject histories can be cross-object. For example, if a person got a speeding ticket in one vehicle, that record applies to the subject regardless of what vehicle that person drives at other times. In some further embodiments, the received plurality of data may also include motor vehicle records and/or property records related to one or more objects associated with the subject.

As described herein, the data may be received 102, 602 from a plurality of sources and may include reference data (e.g., data that is relatively more static or persistent) and sensor data. In some instances, TM computing device 202 receives 102, 602 the data in response to a specific request. In other instances, TM computing device 202 receives 102, 602 data on a periodic or continuous basis.

As shown in FIG. 2, TM computing device 202 is configured to receive (102, 602) this plurality of data from a variety of sources, such as third-party servers 206, a plurality of sensors 208, and/or one or more client computing device 210. Third-party servers 206 may represent data sources that provide information—such as reference information—to TM computing device 202. For example, third-party servers 206 may be associated with insurance providers, governmental entities (e.g., law enforcement), financial institutions, repair or maintenance contracting parties, medical service providers, transportation service providers (e.g., vehicle sharing systems, public transportation systems, etc.) and/or other third parties. Third-party servers 206 each may be associated with a third-party database 212. Sensors 208 are devices capable of sensing attributes of their environment. Sensors 208 can be a part of an object being assessed (e.g., a vehicle, home, building) and/or can be disposed within a mobile device, and/or any other object that the sensors 208 can then provide the attributes of, as described herein.

In the exemplary embodiment, client computing devices 210 are computers that include a web browser or a software application, which enables client computing devices 210 to access TM computing device 202 via network 204 using the Internet. Client computing device 210 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, chat bots, smart glasses, AR/VR devices, or other web-based connectable equipment or mobile devices. In some embodiments, client computing devices are capable of requesting and/or accessing information from or providing information to TM computing device 202 (e.g., providing reference information and/or sensor data; requesting container files; requesting NFTs, etc.). Client computing device 210 may be associated with a subject, a user of an object being assessed, or a user otherwise associated with the subject or object (e.g., buyer, seller, insurer, assessor).

System 200 also includes one or more collection component(s) 214. Collection components 214 can include one or more client-side devices, and/or one or more server-side device(s). Collection components 214 can be embodied as standalone computing devices or servers configured to receive and package (e.g., collect) information from any of third-party servers 206, sensors 208, and client computing device 210, directly and/or indirectly (e.g., via network 204). In particular, collection components 214 may be continuously or periodically receiving information (about subjects and/or objects) from a variety of sources, as described herein. Collection components 214 may compile and parse or partition this received data, such that data associated with one subject, one object, one subject and one object, one subject across multiple objects, and/or one object across multiple subjects is collected and available. For example, collection components 214 may process and index any received data based on a subject identifier or an object identifier (e.g. an alphanumeric identifier uniquely associated with a subject or object), for retrieval by TM computing device 202. It should also be understood that collection component 214 may process and compile data that is related or applicable to more than one subject, more than one object, and/or a subject(s) and object(s) simultaneously.

In some instances, this indexing or cataloging function may involve significant processing to determine that data received from disparate sources is, in fact, associated with one common subject and/or object. This processing may include any suitable text-or image-based processing, location processing or geo-locating, and the like, and may involve one or more machine-learning or artificial intelligence techniques. Although collection component 214 is shown as a separate device in FIG. 2, it should be understood that in some embodiments, collection component 214 may be implemented as an executable module or separate processing component of TM computing device 202, without departing from the scope of the present disclosure.

TM computing device 202 receives the packaged or indexed data from collection component 214 and generates 104 at least one NFT based on the received (102, 602) data. In particular, as described herein, TM computing device 202 generates a container file including the data (e.g., as a subject history and/or an object history) and generates 104, 604 the NFT for the subject and/or object based upon the container file. It should also be understood that TM computing device 202 may receive packaged or indexed data from collection component 214 that is related or applicable to more than one subject, more than one object, and/or a subject(s) and object(s) simultaneously. In such cases, TM computing device 202 may generate one more corresponding NFTs and/or one or more related supertokens including aggregations and/or pointers to the NFTs forming the supertokens.

In one exemplary embodiment, as shown in FIG. 2, TM computing device 202 includes a plurality of components, including a translation component 220, an encryption component 222, a provisioning component 224, and a modelling component 226. These components may be representations of specialized programming and/or computer-executable code executed by one or more processing components of TM computing device 202.

To generate 104, 604 the NFT based upon the received (102, 602) data, in some embodiments, TM computing device 202 executes or initializes translation component 220 thereof. Translation component 220 may be programmed or configured to perform any necessary or useful translation of the received (102, 602) data. That is, translation component 220 may translate or transform the received (102) data into an object history for an object and/or may translate or transform the received (602) data into a subject history for a subject. Translation component 220 may perform various processing on the received (102, 602) data, such as re-formatting, standardization, parsing, re-sizing, and the like, to generate the history for the object or subject. It should also be understood that translation component 220 may output translations of received (102, 602) data that is applicable to more than one subject, more than one object, and/or a subject(s) and object(s) simultaneously.

Subsequently, TM computing device 202 may execute or initialize encryption component 222 to encrypt the subject history and/or object history. More particularly, encryption component 222 may be configured or programmed to hash or otherwise encrypt the subject history and/or object history to generate the container file and, thereafter, generate 104, 604 the encrypted NFT based upon the container file.

TM computing device 202 stores 106, 606 the container file and NFT in a cloud-based electronic ledger (e.g., a blockchain) for secure, immutable storage. In some embodiments, TM computing device 202 may execute or initialize provisioning component 224 to store 106, 606 the container file and NFT. More specifically, provisioning component 224 may push or transmit container files and/or NFTs to other node devices 230 that maintain the electronic ledger. Provisioning component 224 may additionally store the container files and/or NFTs on any other cloud-based storage device, such as one or more databases 232. Moreover, provisioning component 224 may be configured or programmed to push any updates to container files and/or NFTs to node devices 230, in response to any updates as described herein.

TM computing device 202 accesses 108 the NFT and associated container file to perform the various more artificial intelligence (AI), machine learning (ML), and/or cognitive computing functions techniques described herein, to analyze the stored data and identify, for example, behaviors, routines, risks, and past values, as well as to predict affects and/or future values based upon that stored data. In one exemplary embodiment, TM computing device 202 executes or initializes modelling component 226 to perform these analyses. Modelling component 226 may be configured or programmed to train one or more models and/or execute such trained models to analyze subject histories and/or object histories and output associated subject assessments and/or object assessments. In some embodiments, TM computing device 202 determines that one or more data elements are missing, where such data elements are important in the assessment of a subject and/or an object. In such cases, TM computing device 202 may communicate with one or more data sources (e.g., via network 204) to retrieve and access such missing data.

Modelling component 226 may also include such trained models that are pre-programmed to assign weighting factors and/or decay factors to certain input data, such as factors relating to a time associated with the input data (e.g., how much time has elapsed since the data was captured) or factors relating to a major change associated with the subject/object.

Based upon these executed one or more AI, ML, and/or cognitive computing functions, TM computing device 202 (e.g., via modelling component 226) calculates or generates 110, 610 one or more subject assessment(s) for the subject(s) and/or one or more object assessment(s) for the object(s). In one or more embodiments, TM computing device 202 generates 110, 610 the subject/object assessment(s) including a corresponding risk/reliability/value score or metric, as a quantitative assessment of the subject/object(s) based upon the reference and sensor data. TM computing device 202 may additionally generate 110, 610 one or more reports or other records associated with the subject/object(s) and/or the subject/object assessment(s). TM computing device 202 may then provide 112, 612 the subject assessment(s) and/or object assessment(s) and any reports/records within one or more messages to a user associated with the subject(s) or object(s) (e.g., a seller, buyer, insurance underwriter, etc.). TM computing device 202, advantageously, may maintain and provide 112, 612 those assessments (e.g., as NFTs) over time, even when a person changes insurance companies or has other major life events. TM computing device 202 may additionally or alternatively provide 112, 612 recommendations to one or more persons to improve an associated subject/object assessment. For example, TM computing device 202 may provide 112, 612 a recommendation that a person schedule more frequent or consistent maintenance on a vehicle to improve the object assessment associated with the vehicle. As another example, TM computing device 202 may provide 612 a recommendation that a person travel at less risky times or reduce their speed of driving, to improve a subject assessment of that person (e.g., which may, in turn, reduce an insurance premium paid by that person).

In some embodiments, processes 100, 600 also include updating 120, 620 the data stored in the container file and/or the NFT. Updating 120, 620 may be conducted in response to a request for a report/assessment, in response to receiving 102, 602 updated data, periodically, and/or under any other appropriate condition. In some embodiments, processes 100, 600 may also include a manual or human review 122, 622 of any functions performed by and/or outputs from TM computing device 202.

Turning to FIG. 2 for further explanation of system 200, TM computing device 202 is in communication with plurality of sensors 208. In particular, TM computing device 202 receives sensor data from sensors 208, for further processing to generate and maintain subject histories and assessments, as described herein. Sensors 208 may include, but are not limited to, vehicle sensors, home sensors, infrastructure sensors, sensors in one or more mobile devices, and/or any other type of sensor that may be used to analyze an event, object, environment, behavior, etc.

Vehicle-based sensors may include navigation, communications, safety, security, and/or “infotainment” data. For example, vehicle telematics data collected may include, but is not limited to braking and/or acceleration data, navigation data, vehicle settings (e.g., seat position, mirror position, temperature, or air control settings, etc.), remote-unlock and/or remote-start data (e.g., determining which user computer device is used to unlock or start vehicle) and/or any other telematics data. Sensors 208 may also include sensors that detect conditions of vehicle, such as covered distance, speed, acceleration, gear, braking, and other conditions related to the operation of vehicle, for example: at least one of a measurement of at least one of speed, direction rate of acceleration, rate of deceleration, location, position, orientation, and rotation of the vehicle, and a measurement of one or more changes to at least one of speed, direction rate of acceleration, rate of deceleration, location, position, orientation, and rotation of the vehicle. Furthermore, plurality of sensors 208 may include impact sensors that detect impacts to vehicle, including force and direction and sensors that detect actions of vehicle, such the deployment of airbags. In some embodiments, plurality of sensors 208 may detect the presence of driver and one or more passengers (not shown) in vehicle. In these embodiments, plurality of sensors 208 may detect the presence of fastened seatbelts, the weight in each seat in vehicle, heat signatures, or any other method of detecting information about driver and/or passengers in vehicle.

In the case of property, such as, but not limited to, a home and/or a business property, sensors 208 may be deployed (and/or embedded) throughout property. Sensors 208 may include, broadly, any kind of sensor (e.g., temperature, humidity, motion, sound/audio signal, light, etc.). In some embodiments, sensors 208 specifically include a smart thermostat. Sensors 208 may be part of a smart home system or one or more “Internet of Things” devices or appliances, such as smart locks, furnaces, air conditioners, thermostats, light bulbs, appliances, sensors, and any other device or processor, which may be connected through a centralized smart home hub. The smart home system may include a home security system which may include security devices such as, for example, door or window sensors (e.g., to detect when doors or windows or open, when windows are broken), motion sensors (e.g., to detect when someone is present within range of the sensor), security cameras (e.g., for capturing audio/video of particular areas in or around the structure on the property, such as a doorbell camera), key pads (e.g., for enabling/disabling the security system), panic buttons (e.g., for alerting a security service or authorities of an emergency situation), security hubs (e.g., for integrating individual security devices into a security system, for centrally controlling such devices, for interacting with third parties), electric door locks, or smoke/fire/carbon monoxide detectors. Such “security devices” broadly represent devices that may detect potential contemporaneous risks to the property or its occupants (e.g., intrusion, fire, health).

Additional sensors 208 may include subject sensors, such as sensors within mobile devices carried and operated by a person (subject), wearable devices worn by a person, pairing or connectivity data of devices operated by the person, location data, and the like.

In the exemplary embodiment, sensors 208 are enabled to transmit sensor data to TM computing device 202 using the Internet. More specifically, sensors 208 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. In some embodiments, sensors 208 may be associated with any device capable of accessing the Internet including, but not limited to, a mobile device, a desktop computer, a laptop computer, a personal digital assistant (PDA), a cellular phone, a smartphone, a tablet, a phablet, wearable electronics, smart watch, chat bot, smart glasses, AR/VR device, or other web-based connectable equipment or mobile devices.

In the exemplary embodiment, third-party servers 206 are computers that include a web browser or a software application, which enables third-party servers 206 to access TM computing device 202 using the Internet, as described herein. Third-party servers 206 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, chat bots, or other web-based connectable equipment or mobile devices.

In some embodiments, database 232 may store sensor data, reference data, container files, NFTs, blockchains, ownership information, preferences provided by a policyholder or other user, subject histories, subject assessments, object histories, object assessments, and/or any other data described herein. In the exemplary embodiment, database 232 may be stored remotely from TM computing device 202. In some embodiments, database 232 may be decentralized. In the exemplary embodiment, a person may access database 232 by logging onto TM computing device 202, as described herein (e.g., via a client computing device 210).

Node computing device 230 may be similar to TM computing device 202, client computing devices 210, and/or third-party servers 206. Broadly, node devices 230 may be any computer device capable of maintaining an electronic ledger (e.g., a blockchain).

### Exemplary Computer-Implemented Methods for Generating and Maintaining Subject-Related and Object-Related NFTs

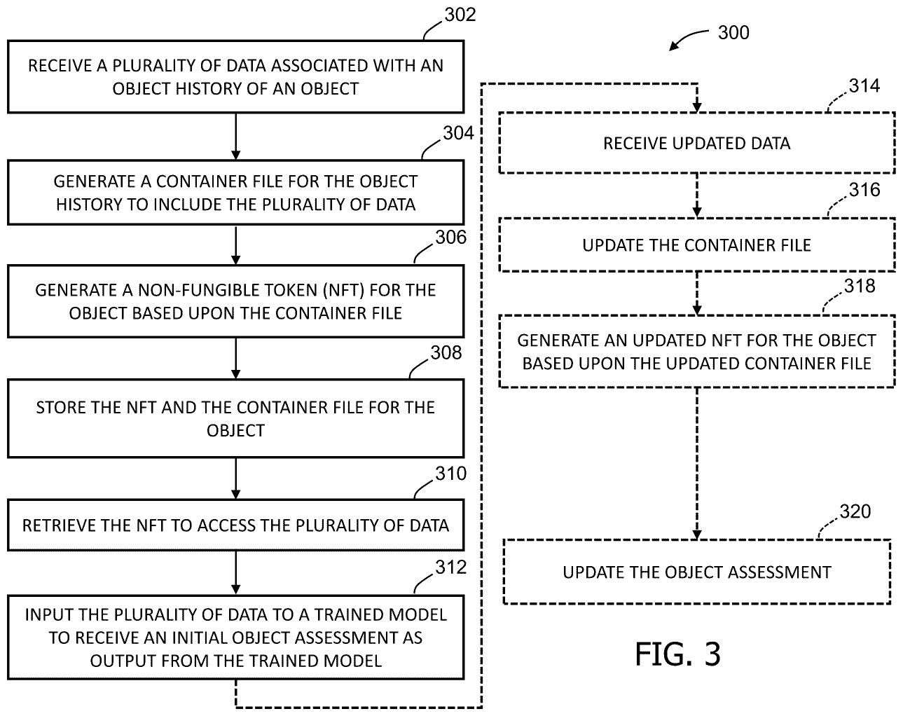

FIG. 3 illustrates a flow chart of an exemplary computer-implemented process 300 for generating and maintaining NFTs for object histories and assessments, using the system 200 (shown in FIG. 2).

Process 300 may be implemented by a computing device, for example TM computing device 202 (shown in FIG. 2). In the exemplary embodiment, TM computing device 202 receives 302 a plurality of data associated with an object history of an object, generates 304 a container file for the object history to include the plurality of data, and generates 306 a non-fungible token (NFT) for the object based upon the container file. TM computing device 202 also stores 308 the NFT and the container file for the object, retrieves 310 the NFT to access the plurality of data, and inputs 312 the plurality of data to a trained model to receive an initial object assessment as output from the trained model.

In some embodiments, process 300 also includes receiving 314 updated data associated with the history of the object, updating 316 the stored container file with the updated data, generating 318 an updated NFT for the object based upon the updated container file, and updating 320 the object assessment based on the updated NFT and/or updated container file. These steps may be iterated periodically or continuously to maintain currency of the NFT and the associated object assessment.

Process 300 may include additional, fewer, and/or alternative steps. In some embodiments, the subject is an object to be insured, the subject assessment includes a reliability score related to a value of the object based upon previous usage of the object, and receiving 302 includes receiving the plurality of data corresponding to usage of the object by a plurality of persons. In some embodiments, process 300 further includes receiving (e.g., receiving 314) updated data associated with the object, the updated data indicating an ownership change of the object from a previous owner to a new owner, updating (e.g., updating 316) the container file with at least one of the updated data, updating (e.g., generating 318) the NFT based upon the updated container file, and causing the trained model to apply a decay factor to data associated with the previous owner of the object in generating subsequent subject assessments of the object.

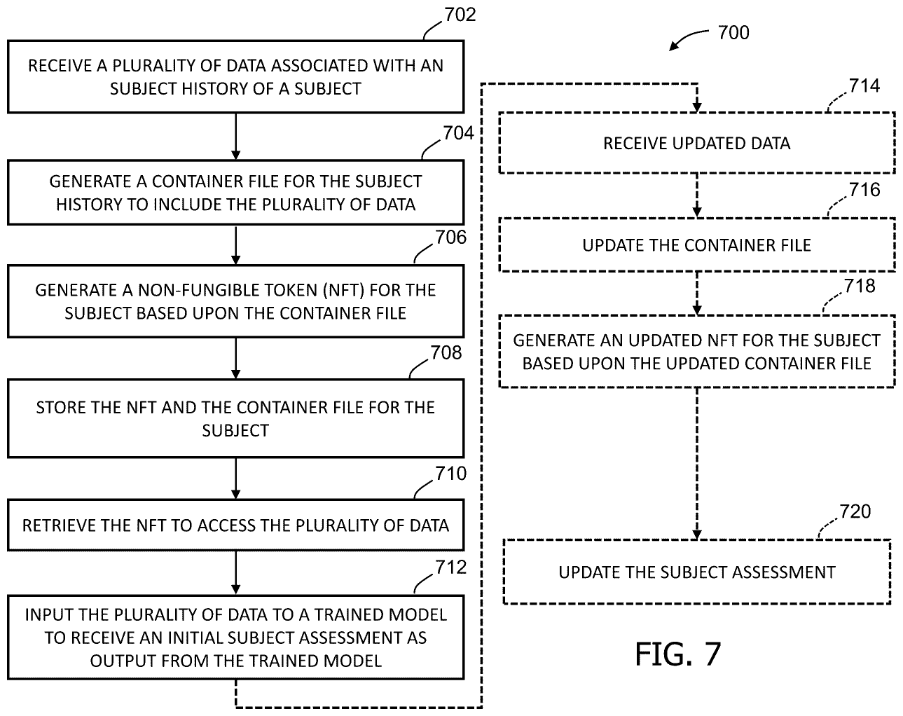

FIG. 7 illustrates a flow chart of an exemplary computer-implemented process 700 for generating and maintaining NFTs for subject histories and assessments, using the system 200 (shown in FIG. 2).

Process 700 may be implemented by a computing device, for example TM computing device 202 (also shown in FIG. 2). In the exemplary embodiment, TM computing device 202 receives 702 a plurality of data associated with a subject history of a subject, generates 704 a container file for the subject history to include the plurality of data, and generates 706 a non-fungible token (NFT) for the subject based upon the container file. TM computing device 202 also stores 708 the NFT and the container file for the subject, retrieves 710 the NFT to access the plurality of data, and inputs 712 the plurality of data to a trained model to receive an initial subject assessment as output from the trained model.

In some embodiments, process 700 also includes receiving 714 updated data associated with the history of the subject, updating 716 the stored container file with the updated data, generating 718 an updated NFT for the subject based upon the updated container file, and updating 720 the subject assessment based on the updated NFT and/or updated container file. These steps may be iterated periodically or continuously to maintain currency of the NFT and the associated subject assessment.

Process 700 may include additional, fewer, and/or alternative steps. In some embodiments, the subject is an individual person, and wherein the subject assessment includes a quantitative assessment of one or more behaviors of the person, and receiving 702 includes receiving the plurality of data corresponding to the one or more behaviors of the person during usage of multiple objects by the person.

### Exemplary User Computing Device

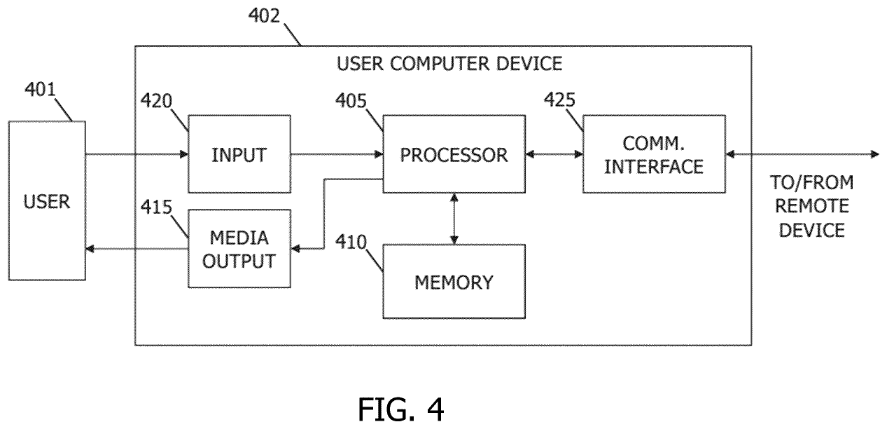

FIG. 4 depicts an exemplary configuration of a user computer device 402 that may be operated by a user 401. User computer device 402 may include, but is not limited to, third-party servers 206, sensors 208, client computer devices 210, collection component 214, and/or node devices 230 (all shown in FIG. 2). User computer device 402 may include a processor 405 for executing instructions. In some embodiments, executable instructions are stored in a memory area 410. Processor 405 may include one or more processing units (e.g., in a multi-core configuration). Memory area 410 may be any device allowing information such as executable instructions and/or transaction data to be stored and retrieved. Memory area 410 may include one or more computer readable media.

User computer device 402 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively coupleable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (extended Reality) headsets).

In some embodiments, media output component 415 may be configured to present a graphical user interface (e.g., a web browser and/or a client application) to user 401. A graphical user interface may include, for example, an interface for displaying information from a container file. In some embodiments, user computer device 402 may include an input device 420 for receiving input from user 401. User 401 may use input device 420 to, without limitation, select and/or enter information for the container file. Input device 420 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 415 and input device 420.

User computer device 402 may also include a communication interface 425, communicatively coupled to a remote device such as the TM computing device 202 (shown in FIG. 2). Communication interface 425 may include, for example, a wired or wireless network adapter and/or a wireless data transceiver for use with a mobile telecommunications network.

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from TM computing device 202. A client application allows user 401 to interact with, for example, TM computing device 202. For example, instructions may be stored by a cloud service, and the output of the execution of the instructions sent to the media output component 415.

Processor 405 executes computer-executable instructions for implementing aspects of the disclosure. In some embodiments, the processor 405 is transformed into a special purpose microprocessor by executing computer-executable instructions or by otherwise being programmed.

### Exemplary Server Device

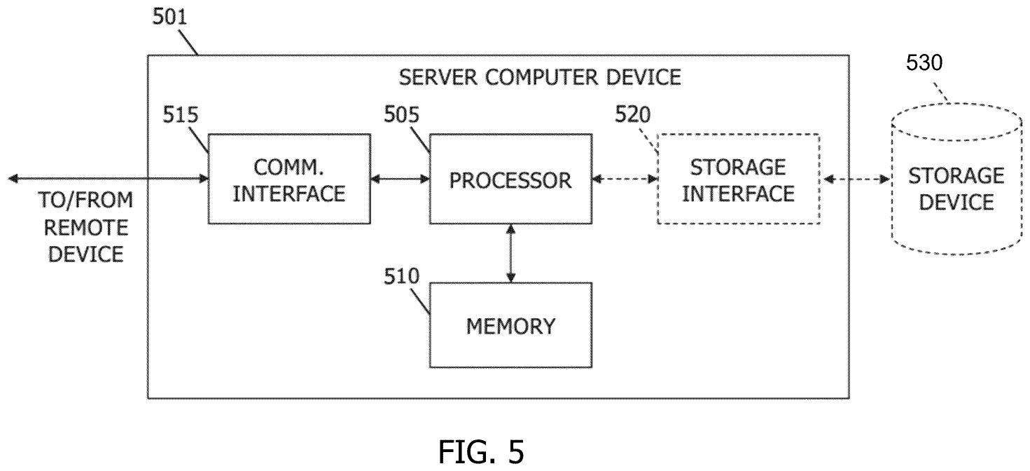

FIG. 5 depicts an exemplary configuration of server computer device 501, in accordance with one embodiment of the present disclosure. Server computer device 501 may include, but is not limited to, TM computing device 202, third-party server 206, collection component 214, and/or node devices 230 (all shown in FIG. 2). Server computer device 501 may include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 501 is capable of communicating with a remote device such as another server computer device 501, node devices 230, sensors 208, or client computer devices 210 (shown in FIG. 2). For example, communication interface 515 may receive messages from client computer devices 210 via the Internet, as illustrated in FIG. 2.

Processor 505 may also be operatively coupled to a storage device 530. Storage device 530 may be any computer-operated hardware suitable for storing and/or retrieving data, such as, but not limited to, data associated with database 232 or third-party database 212 (shown in FIG. 2). In some embodiments, storage device 530 may be integrated in server computer device 501. For example, server computer device 501 may include one or more hard disk drives as storage device 530. In other embodiments, storage device 530 may be external to server computer device 501 and may be accessed by a plurality of server computer devices 501. For example, storage device 530 may include a storage area network (SAN), a network attached storage (NAS) system, and/or multiple storage units such as hard disks and/or solid-state disks in a redundant array of inexpensive disks (RAID) configuration.

In some embodiments, processor 505 may be operatively coupled to storage device 530 via a storage interface 520. Storage interface 520 may be any component capable of providing processor 505 with access to storage device 530. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 530.

Processor 505 may execute computer-executable instructions for implementing aspects of the disclosure. In some embodiments, the processor 505 may be transformed into a special purpose microprocessor by executing computer-executable instructions or by otherwise being programmed. For example, the processor 505 may be programmed with the instructions such as illustrated in FIGS. 1, 3, and 6-12.

### Exemplary System and Processes for Generation and Maintenance of Rating Models and Subsequent NFT Generation and Maintenance

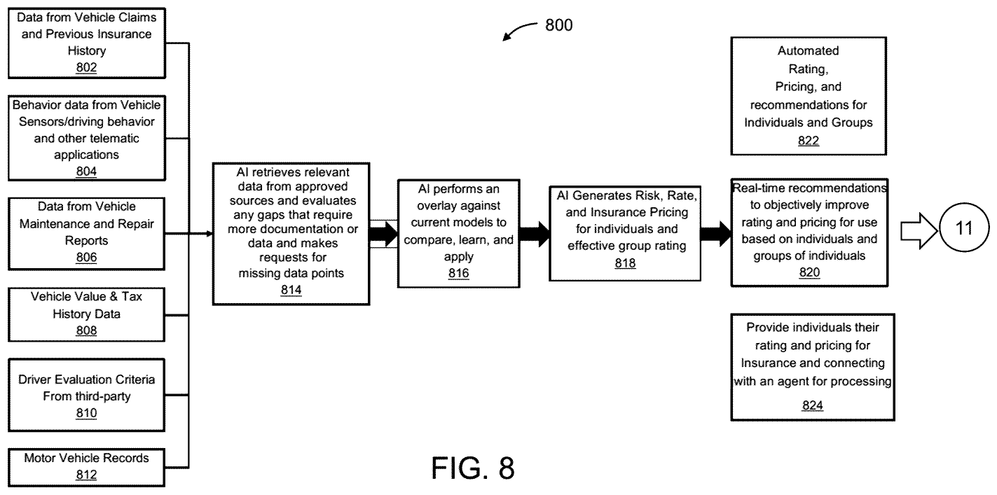

FIG. 8 illustrates a flow chart of an exemplary process 800 for generating and maintaining one or more subject rating models in accordance with one embodiment of this disclosure.

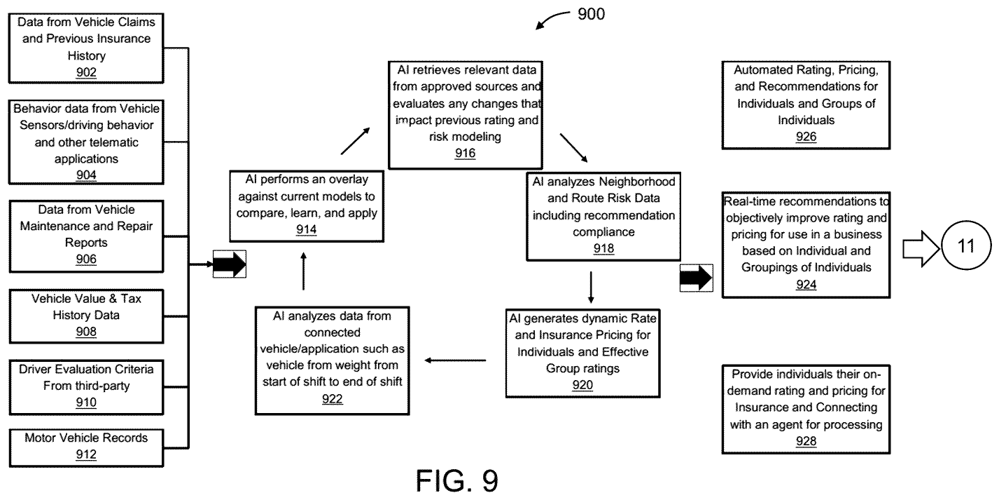

In one example, the subject rating models described herein may be associated with one or more on-demand platforms, such as a TNC. Although FIGS. 8 and 9 are described in view of TNC-and driving-based gig work, one having skill in the art would understand that the systems and methods described herein may also be used for other individuals, including, but not limited to, persons performing other types of gig work (temporary or freelance work performed by an independent contractor on an informal or on-demand basis) and/or non-work-based groups of individuals.

In the exemplary embodiment, the subject rating models may be associated with contracted terms, such as for insurance for the driver while working for the TNC. For example, the contracted term for the driver may be for one year. The subject rating models are configured to provide a starting point on driving behavior for drivers and to provide recommendations to improve that driving behavior to potentially reduce their cost of vehicle insurance for professional and/or personal driving.

In the exemplary embodiment, TM computing device 202 (shown in FIG. 2) receives a plurality of data associated with an individual and/or a group of individuals, such as, for example, a group of drivers at a TNC. As shown in FIG. 8, such data may include, for example but without limitation, data from previous vehicle insurance claims and previous insurance history 802 for the corresponding individual and/or any vehicles associated with that individual. The previous vehicle insurance claims and previous insurance history 802 may be for multiple vehicles all associated with the same individual. Furthermore, the previous vehicle insurance claims and previous insurance history 802 may also include information about other individuals that may be associated with the same vehicles, such as family members and/or roommates that may also operate the vehicle.

The received information may also include behavior data 804 from vehicle sensors including, but not limited to, driving behavior and other telematics applications associated with the vehicle(s) associated with the corresponding individuals. The driving behavior data 804 may include, but is not limited to, telematics data provided by sensors in the vehicle. This telematics data may be provided directly from the vehicle, from one or more mobile computer devices in communication with the vehicle, from the manufacturer of the vehicle, and/or from one or more devices connected to the vehicle (such as provided by an insurance company).

The received information may further include data from vehicle maintenance and repair reports 806 (e.g., inspection records, maintenance/service records, etc.) and vehicle value and tax history data 808. The received information additionally may include driver evaluation criteria 810 from a third-party application, such as that provided by a TNC. This driver evaluation criteria 810 may include one or more ratings of the driver. At least one of the ratings of the driver may be based upon feedback provided by users of the application, where the driver provided driving and/or delivery services for those users. For example, after a ride with a ride-sharing application, most applications allow the rider to provide ratings of the driver that may include a one-to-five-star rating on how the ride was, rating how good of a driver the individual was, and/or how safe the rider felt during the ride. The driver evaluation criteria 810 may also contain information about the performance of the driver in their duties with the TNC. This performance information may include, but is not limited to, percentage/number of attempted tasks, percentage/number of completed tasks, average time to complete tasks, average time to complete tasks compared to average expected completion time, etc. In some further embodiments, the received plurality of data may also include motor vehicle records 812 and/or property records related to the object. As described herein, these subject histories can be cross-object. For example, if a person got a speeding ticket in one vehicle, that record applies to the subject regardless of what vehicle that person drives at other times.

As described herein, TM computing device 202 is configured to receive this plurality of data from a variety of sources, such as third-party servers 206, a plurality of sensors 208, and/or one or more client computing devices 210 (all shown in FIG. 2). The data may include reference data (e.g., data that is relatively more static or persistent) and sensor data. In the exemplary embodiment, the plurality of data includes driving data for when the driver is working for the TNC and when the driver is off-duty and driving for personal reasons. This provides a holistic picture of the drivers and their driving performance, which greatly improves the ability to rate those drivers. In some instances, TM computing device 202 receives the data in response to a specific request. In other instances, TM computing device 202 receives the data on a periodic or continuous basis.

Third-party servers 206 may represent data sources that provide information—such as reference information—to TM computing device 202. For example, third-party servers 206 may be associated with insurance providers, governmental entities (e.g., law enforcement), financial institutions, repair or maintenance contracting parties, medical service providers, transportation service providers (e.g., vehicle sharing systems, public transportation systems, etc.), on-demand platforms, and/or other third parties. Sensors 208 are devices capable of sensing attributes of their environment. Sensors 208 can be a part of an object being assessed (e.g., a vehicle, home, building) and/or can be disposed within a mobile device, and/or any other object that the sensors 208 can then provide the attributes of, as described herein.

In the exemplary embodiment, TM computing device 202 includes one or more machine learning (ML) trained models and/or one or more trained artificial intelligence (AI) systems. In the exemplary embodiment, TM computing device 202 retrieves 814 relevant data from approved sources and evaluates any gaps that require more documentation or data and makes requests for any missing data points. TM computing device 202 may transmits requests for any detected missing data points to one or more of the third-party servers 206 and/or one or more client computing devices 210.

In the exemplary embodiment, TM computing device 202 executes the AI/models to perform 816 one or more overlays against the current models to compare, learn, and apply. The one or more overlays are used to determine if adjustments and/or updates are needed to one or more current models to continue to evolve those models. In some embodiments, TM computing device 202 analyzes the data for each driver to determine how good or bad of a driver that they are. For example, how does the driver's experience as a professional driver through the TNC change or affect their personal driving? In some situations, the driver's experience as a professional driver may improve their personal driving. In other situations, the driver's personal driving may be worse after a day of driving others. In many cases, TNC drivers are rated by their passengers and may take more care to preserve their good ratings.

In the exemplary embodiment, TM computing device 202 generates 818 risk, rate, and insurance pricing for individuals and effective group ratings. In some embodiments, the ratings may include mutual, standard, and substandard ratings, where those rated mutual are highly desirable customers.

In the exemplary embodiment, TM computing device 202 outputs real-time recommendations 820 to objectively improve rating and pricing for use based on individuals and groups of individuals. For example, the system 200 may be configured for analyzing the drivers of a TNC. For the TNC, the group of drivers are mutually rating as the group of people selected to be drivers by the TNC. The output of real-time recommendations may be configured to reduce the risk associated with the group of drivers. For example, TM computing device 202 may determine which drivers are rated better than others and would therefore be lower risk than other drivers. These lower risk drivers may be presented to the TNC to inform the TNC that these drivers are associated with lower premiums, while these other higher-risk drivers are associated with higher premiums. The TNC may use this risk and rating information to adjust the list of drivers that it selects. The TNC may also inform the higher risk drivers to adjust their driving to lower their costs. The TNC may also share the cost savings of lower premiums with the lower risk drivers.

In the exemplary embodiment, TM computing device 202 also outputs automated rating, pricing, and recommendations 822 for individuals and groups. The rating, pricing, and recommendations 822 may be provided to the drivers to show how they are performing and how they may improve. The rating, pricing, and recommendations 822 may include steps that a driver may take to improve their ratings. In some embodiments, improvements may be tied to bonuses or other rewards. As the driver's ratings improve the cost of insurance for them may go down. In some embodiments, a portion of this cost reduction may be shared with the corresponding drivers. In some of these embodiments, TM computing device 202 generates lists or groups of drivers that are in the same risk or rating categories. For example, TM computing device 202 may generate a list of the drivers associated with the TNC that are in the mutual category, a list of those in the standard category, and a list of those in the substandard category. TM computing device 202 may use other categories as desired.

In the exemplary embodiment, TM computing device 202 provides 824 individuals with their rating and pricing for insurances and connecting with an agent for processing. For example, a driver that is covered under a blanket insurance from the TNC when the driver is working for the TNC and has a good rating and/or low risk may be approached for personal insurance with offers based upon their rating/risk.

In some further embodiments, TM computing device 202 may execute the models to determine driving patterns indicative of drivers for TNC applications. Accordingly, TM computing device 202 may be able to determine which drivers are working for TNC applications and when based on their driving behavior compared to other drivers. In some embodiments, TM computing device 202 may identify drivers that are working for a TNC application and are considered good drivers. TM computing device 202 may transmit information about those identified drivers to agents and reach out to the identified drivers with pricing for insurance for those drivers.

In some embodiments, TM computing device 202 stores profiles for drivers/vehicles in various NFTs. In some of these embodiments, each profile is stored in its own NFT. In other embodiments, groups of profiles are stored in various NFTs. For example, 100 profiles may be stored in NFT A while another 100 profiles are stored in NFT B. These NFTs may be accessed by TM computing device 202 to be used in the analysis described in process 900.

FIG. 9 illustrates a flow chart of an exemplary process 900 for generating and maintaining one or more dynamic rating models in accordance with one embodiment of this disclosure. In one example, the dynamic rating models described herein may be associated with one or more transportation network companies (TNC). The dynamic rating models described herein are configured to provide real-time information that could help a driver earn more money, earn a reward, or a different level of status while driving that day. Some of the information determined by the dynamic rating models includes determining when the driver may be more aggressive, safer, more or less observant, more or less reactive, and/or other attributes. Furthermore, the dynamic rating models may be used to determine what happens when a driver receives one or more recommendations from the system and ignores those recommendations.

In the exemplary embodiment, dynamic rating process 900 is configured to help to evaluate drivers accurately and potentially from different perspectives to determine ratings for those drivers and, for TNC applications, determine risks and insurance costs for those drivers. For example, if 90% of the drivers for a TNC are high-risk, then the TNC may need to re-evaluate its driver recruiting methodology to reduce its insurance costs. Furthermore, dynamic rating process 900 may provide recommendations to improve the ratings and/or risks associated with each driver, while providing those recommendations to the drivers in real-time. For example, dynamic rating process 900 may inform a driver that they are entering a lower speed zone, such as a school zone. The would be helpful, especially where the driver is not familiar with the area. Another recommendation may be where dynamic rating process 900 determines that the driver is not coming to a complete stop at stop signs, and dynamic rating process 900 recommends counting to two or another method of ensuring that the driver comes to a complete stop.

In other embodiments, dynamic rating process 900 allows for regular updates to pricing for insurance for the individuals and/or groups. In one embodiment, dynamic rating process 900 may analyze the last few months of data about the driving behavior of the driver and use that to determine a price of insurance for the next month. Dynamic rating process 900 may also provide driving recommendations to improve the price for the following month and/or provide encouragement/congratulations for achieving improvement and reduced insurance costs.

In the exemplary embodiment, TM computing device 202 (shown in FIG. 2) receives a plurality of data associated with an individual and/or a group of individuals, such as, for example, a group of drivers at a transportation network company (TNC). As shown in FIG. 9, such data may include, for example but without limitation, data from previous vehicle insurance claims and previous insurance history 902 for the corresponding individual and/or any vehicles associated with that individual. The previous vehicle insurance claims and previous insurance history 902 may be for multiple vehicles all associated with the same individual. Furthermore, the previous vehicle insurance claims and previous insurance history 902 may also include information about other individuals that may be associated with the same vehicles, such as family members and/or roommates that may also operate the vehicle.

The received information may also include behavior data 904 from vehicle sensors including, but not limited to, driving behavior and other telematics applications associated with the vehicle(s) associated with the corresponding individuals. The driving behavior data 904 may include, but is not limited to, telematic data provided by sensors in the vehicle. This telematics data may be provided directly from the vehicle, from one or more mobile computer devices in communication with the vehicle, from the manufacturer of the vehicle, and/or from one or more devices connected to the vehicle (such as provided by an insurance company).

The received information may further include data from vehicle maintenance and repair reports 906 (e.g., inspection records, maintenance/service records, etc.) and vehicle value and tax history data 908. The received information additionally may include driver evaluation criteria 910 from third-party application, such as that provided by a TNC. This driver evaluation criteria 910 may include one or more ratings of the driver. At least one of the ratings of the driver may be based upon feedback provided by users of the application, where the driver provided driving and/or delivery services for those users. For example, after a ride with a ride-sharing application, most applications allow the rider to provide ratings of the driver that may include a one-to-five-star rating on how the ride was, rating how good of a driver the individual was, and/or how safe the rider felt during the ride. The driver evaluation criteria 910 may also contain information about the performance of the driver in their duties with the TNC. This performance information may include, but is not limited to, percentage/number of attempted tasks, percentage/number of completed tasks, average time to complete tasks, average time to complete tasks compared to average expected completion time, etc. In some further embodiments, the received plurality of data may also include motor vehicle records 912 and/or property records related to the object. As described herein, these subject histories can be cross-object. For example, if a person got a speeding ticket in one vehicle, that record applies to the subject regardless of what vehicle that person drives at other times.

As described herein, TM computing device 202 is configured to receive this plurality of data from a variety of sources, such as third-party servers 206, a plurality of sensors 208, and/or one or more client computing devices 210 (all shown in FIG. 2). The data may include reference data (e.g., data that is relatively more static or persistent) and sensor data. In the exemplary embodiment, the plurality of data includes driving data for when the driver is working for the TNC and when the driver is off-duty and driving for personal reasons. This provides a holistic picture of the drivers and their driving performance, which greatly improves the ability to rate those drivers. In some instances, TM computing device 202 receives the data in response to a specific request. In other instances, TM computing device 202 receives the data on a periodic or continuous basis.

Third-party servers 206 may represent data sources that provide information—such as reference information—to TM computing device 202. For example, third-party servers 206 may be associated with insurance providers, governmental entities (e.g., law enforcement), financial institutions, repair or maintenance contracting parties, medical service providers, transportation service providers (e.g., vehicle sharing systems, public transportation systems, etc.), on-demand platforms, and/or other third parties. Sensors 208 are devices capable of sensing attributes of their environment. Sensors 208 can be a part of an object being assessed (e.g., a vehicle, home, building) and/or can be disposed within a mobile device, and/or any other object that the sensors 208 can then provide the attributes of, as described herein.

Steps 914-922 illustrate the dynamic flow of dynamic rating process 900 described herein. In the exemplary embodiment, TM computing device 202 includes one or more machine learning (ML) trained models and/or one or more trained artificial intelligence (AI) systems.

In the exemplary embodiment, TM computing device 202 executes the AI/models to perform 914 one or more overlays against the current models to compare, learn, and apply. The one or more overlays are used to determine if adjustments and/or updates are needed to one or more current models to continue to evolve those models. In some embodiments, TM computing device 202 analyzes the data for each driver to determine how good or bad of a driver that they are. For example, how does the driver's experience as a professional driver through the TNC change or affect their personal driving? In some situations, the driver's experience as a professional driver may improve their personal driving. In other situations, the driver's personal driving may be worse after a day of driving others. In many cases, TNC drivers are rated by their passengers and may take more care to preserve their good ratings.

In the exemplary embodiment, TM computing device 202 retrieves 916 relevant data from approved sources and evaluates any changes that impact previous ratings and risk modeling. For example, if a driver received a speeding ticket or have been driving differently since the last time that their information was analyzed. This may lead to an adjustment of the rates and/or premiums of the insurance for that driver.

In the exemplary embodiment, TM computing device 202 analyzes 918 neighborhood and route risk data including recommendation compliance. Recommendation compliance may include determining whether or not the user followed recommendations from TM computing device 202 and/or the TNC application. For example, the driver picks up a passenger at a specific place and the TNC application provides a route to take the passenger on to reach their destination. The TNC application may provide what is calculated to be the saftest route, aka the route with the least risk. However, the driver may decide to take a different route, such as a more scenic route. TM computing device 202 is configured to analyze 918 that deviation from the provided route and determine if that deviation makes sense or is it a riskier behavior.

In the exemplary embodiment, TM computing device 202 generates 920 risk, rate, and insurance pricing for individuals and effective group ratings. In some embodiments, the ratings may include mutual, standard, and substandard ratings, where those rated mutual are highly desirable customers. In some embodiments, TM computing device 202 detects adjustments to the driver's performance throughout the day/shift. These adjustments are compared to changing conditions in and/or around the vehicle, such as, but not limited to, number of passengers, number of packages, transporting people or items, category of service, time spent working, time since last break, time of day, current traffic conditions, safety or riskiness of roads taken, etc. TM computing device 202 determines how these different factors affects the performance of the driver. For example, a driver may perform well for the first three hours of a shift of driving, but then start making more mistakes or becoming a riskier driver in the fourth hour. TM computing device 202 and/or the TNC application may transmit one or more recommendations to the driver to take a break, maybe get some food and/or rest. TM computing device 202 analyzes this data to determine which factors may positively and/or negatively affect a driver performance and overall riskiness. Then TM computing device 202 may provide recommendations to the driver to improve their driving and reduce their risk.

In the exemplary embodiment, TM computing device 202 analyzes 922 data from connected vehicles/applications, such as, but not limited to, vehicle weight from the start of shift to the end of shift. The data includes information about weight, if currently operating, number of passengers (e.g., from number of seatbelts fastened), number of packages in the vehicle, etc.

TM computing device 202 uses this information to determine risk profiles that may change over time, at different times of day, days of week, etc. In some embodiments, coverage for the driver and/or vehicle may also change over time as the risk profile changes. For example, a vehicle may be shared with multiple individuals, such as multiple households. The coverage on the vehicle may change based on whether or not the current driver is the owner of the vehicle or someone who is borrowing the vehicle. This sharing system may be connected to a calendar application showing who is to use the vehicle when.

In the exemplary embodiment, TM computing device 202 is consistently or continuously performing steps 914-922 for some or all of the drivers being analyzed and may perform any steps of dynamic rating process 900 in real time. In some embodiments, TM computing device 202 only analyzes drivers when they are actively driving or working for the TNC application. In other embodiments, TM computing device 202 analyzes each driver on a periodic basis.

In the exemplary embodiment, TM computing device 202 outputs real-time recommendations 924 to objectively improve rating and pricing for use based on individuals and groups of individuals. For example, the system 200 may be configured for analyzing the drivers of a TNC. For the TNC, the group of drivers are mutually rating as the group of people selected to be drivers by the TNC. The output of real-time recommendations may be configured to reduce the risk associated with the group of drivers. For example, TM computing device 202 may determine which drivers are rated better than others and would therefore be lower risk than other drivers. These lower risk drivers may be presented to the TNC to inform the TNC that these drivers are associated with lower premiums, while these other higher-risk drivers are associated with higher premiums. The TNC may use this risk and rating information to adjust the list of drivers that it selects. The TNC may also inform the higher risk drivers to adjust their driving to lower their costs. The TNC may also share the cost savings of lower premiums with the lower risk drivers.

In the exemplary embodiment, TM computing device 202 also outputs automated rating, pricing, and recommendations 926 for individuals and groups. The rating, pricing, and recommendations 926 may be provided to the drivers to show how they are performing and how they may improve. The rating, pricing, and recommendations 926 may include steps that a driver may take to improve their ratings. In some embodiments, improvements may be tied to bonuses or other rewards. As the driver's ratings improve the cost of insurance for them may go down. In some embodiments, a portion of this cost reduction may be shared with the corresponding drivers. In some of these embodiments, TM computing device 202 generates lists or groups of drivers that are in the same risk or rating categories. For example, TM computing device 202 may generate a list of the drivers associated with the TNC that are in the mutual category, a list of those in the standard category, and a list of those in the substandard category. TM computing device 202 may use other categories as desired.

In the exemplary embodiment, TM computing device 202 provides 928 individuals with their rating and pricing for insurances and connecting with an agent for processing. For example, a driver that is covered under a blanket insurance from the TNC when the driver is working for the TNC and has a good rating and/or low risk may be approached for personal insurance with offers based upon their rating/risk.

In some of these embodiments, TM computing device 202 is in communication with one or more third-party servers 206 or one or more sensors 208 associated with the vehicle manufacturer. The vehicle manufacturer third-party server 206 or sensors 208 may provide information about the vehicle, such as, but not limited to, weight, if currently operating, number of passengers (e.g., from number of seatbelts fastened), number of packages in the vehicle, etc. TM computing device 202 may then calculate scalable coverage based on the current risk and value of the vehicle. For example, a delivery vehicle may be more valuable and require more coverage when it is fully loaded with packages rather than when it is mostly empty. Or if a vehicle is shared with other members of the neighborhood. These situations and others illustrate different exposures based upon number of people in the vehicle, current location, current driving behavior, time of day, etc.

In some embodiments, TM computing device 202 stores profiles for drivers/vehicles in various NFTs. In some of these embodiments, each profile is stored in its own NFT. In other embodiments, groups of profiles are stored in various NFTs. For example, 100 profiles may be stored in NFT A while another 100 profiles are stored in NFT B. These NFTs may be accessed by TM computing device 202 to be used in the analysis described in process 800 and/or process 900.

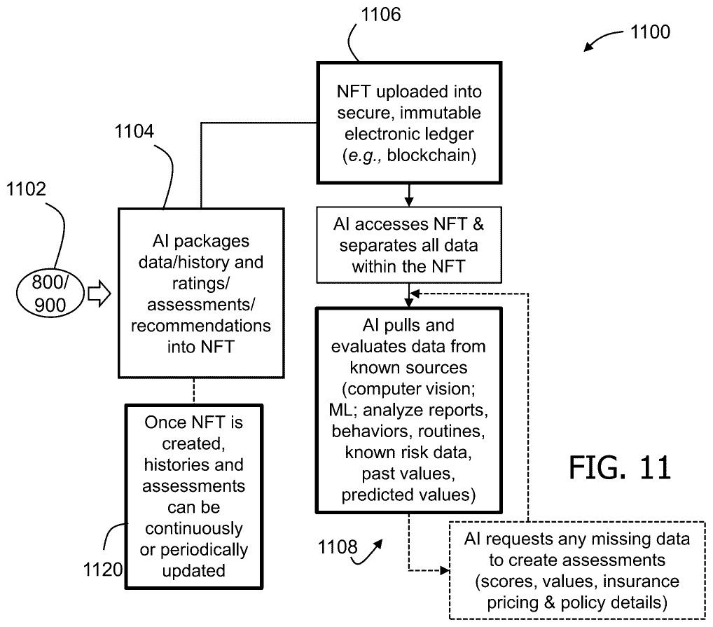

More specifically, process 800 and/or process 900 may feed into process 1100 for generating and maintaining NFTs, as shown in FIG. 11.

TM computing device 202 receives 1102 data output upon completion of process 800 and/or process 900, which may include subject histories, subject ratings or assessments, recommendations, historical ratings/assessments, rewards, insurance policy information, etc. TM computing device generates 1104 at least one NFT based on the received (1102) data. In particular, as described herein, TM computing device 202 generates a container file including the received data and generates 1104 the NFT for the subject (e.g., as related to their associated with an on-demand platform) based upon the container file. It should also be understood that TM computing device 202 may receive data that is related or applicable to more than one subject, more than one object, and/or a subject(s) and object(s) simultaneously. In such cases, TM computing device 202 may generate 1104 one more corresponding NFTs and/or one or more related supertokens including aggregations and/or pointers to the NFTs forming the supertokens.

TM computing device 202 stores 1106 the container file and NFT in a cloud-based electronic ledger (e.g., a blockchain) for secure, immutable storage. TM computing device 202 may then access 1108 the NFT and associated container file to perform the various more artificial intelligence (AI), machine learning (ML), and/or cognitive computing functions techniques described herein, to analyze the stored data and identify, for example, behaviors, routines, risks, and past values, as well as to predict effects and/or future values or make recommendations based upon that stored data. In some embodiments, TM computing device 202 determines that one or more data elements are missing, where such data elements are important in the rating or assessment of a subject and/or an object. In such cases, TM computing device 202 may communicate with one or more data sources (e.g., via network 204, shown in FIG. 2) to retrieve and access such missing data.

TM computing device 202, advantageously, may maintain those ratings or assessments (e.g., as NFTs) over time, even when a person changes insurance companies, changes on-demand platforms, or has other major life events. In some embodiments, processes 1100 may also include updating 1120 the data stored in the container file and/or the NFT. Updating 1120 may be conducted in response to a request for a report/assessment, in response to receiving 1102 updated data, periodically, and/or under any other appropriate condition.

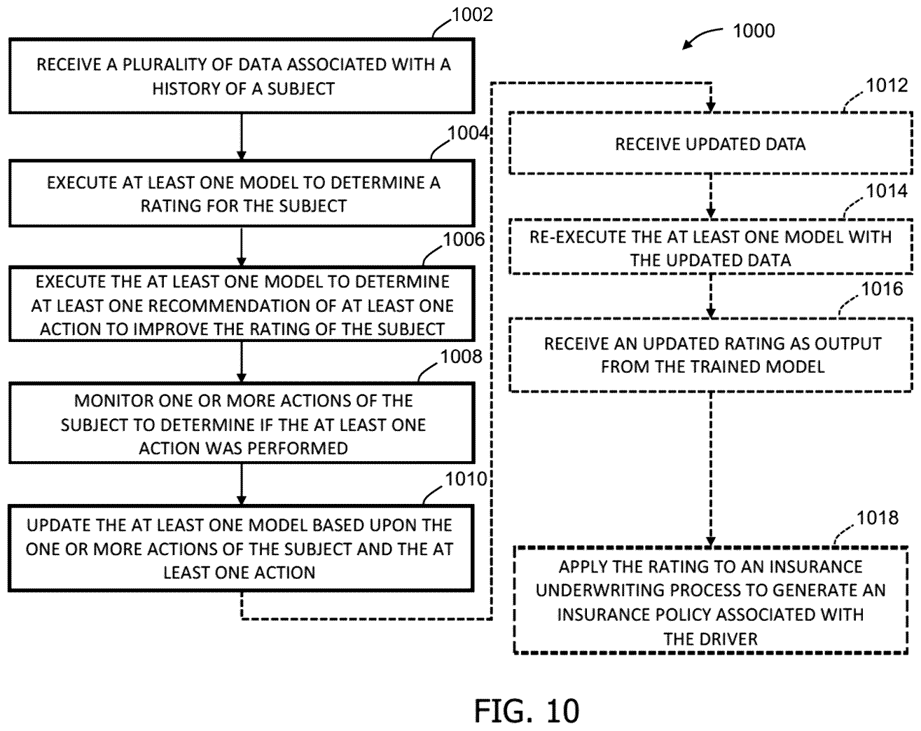

FIG. 10 illustrates a flow chart of an exemplary computer-implemented process 1000 for generating and maintaining one or more rating models, using system 200 shown in FIG. 2.

Process 1000 may be implemented by a computing device, for example, TM computing device 202 (also shown in FIG. 2). In the exemplary embodiment, TM computing device 202 receives 1002 a plurality of data associated with a history of a subject. In some embodiments, TM computing device 202 receives 1002 the plurality of data corresponding to the one or more driving behaviors of the driver during usage operation of a vehicle. TM computing device 202 executes 1004 at least one model with the plurality of data of the history of the subject to determine a rating for the subject. TM computing device 202 executes 1006 the at least one model with the plurality of data of the history of the subject to determine at least one recommendation of at least one action that would improve the rating of the subject. TM computing device 202 monitors 1008 one or more actions of the subject to determine if the at least one action was performed. TM computing device 202 updates 1010 the at least one model based upon the one or more actions of the subject and the at least one action.

In some embodiments, process 1000 also includes receiving 1012 updated data associated with the subject, re-executing 1014 the at least one model with the updated data, and receiving 1016 an updated rating as output from the trained model. In some further embodiments, process 1000 further includes applying 1018 the rating to an insurance underwriting process to generate an insurance policy associated with the driver, where the subject is a driver to be insured.

In some embodiments, the plurality of data includes historical reference data associated with the subject and sensor data captured by one or more sensors associated with the subject.

In additional embodiments, the subject may be associated with a third-party application. In these embodiments, the plurality of data may include evaluation criteria from the third-party application.

In further embodiments, the rating is based in part on the subject's previous compliance with one or more previous recommendations.

In some additional embodiments, the plurality of data includes sensor data received from sensors disposed within at least one of a user computing device or a vehicle operated by the subject.

In some further embodiments, the subject is an individual driver. The at least one model may perform a quantitative assessment of one or more driving behaviors of the driver.

These steps may be iterated periodically or continuously to maintain currency of the models and the associated subject assessment.

Process 1000 may include additional, fewer, and/or alternative steps. In some embodiments, the subject is an individual person, and wherein the subject assessment includes a quantitative assessment of one or more behaviors of the person, and receiving 1002 includes receiving the plurality of data corresponding to the one or more behaviors of the person during usage of multiple objects by the person.

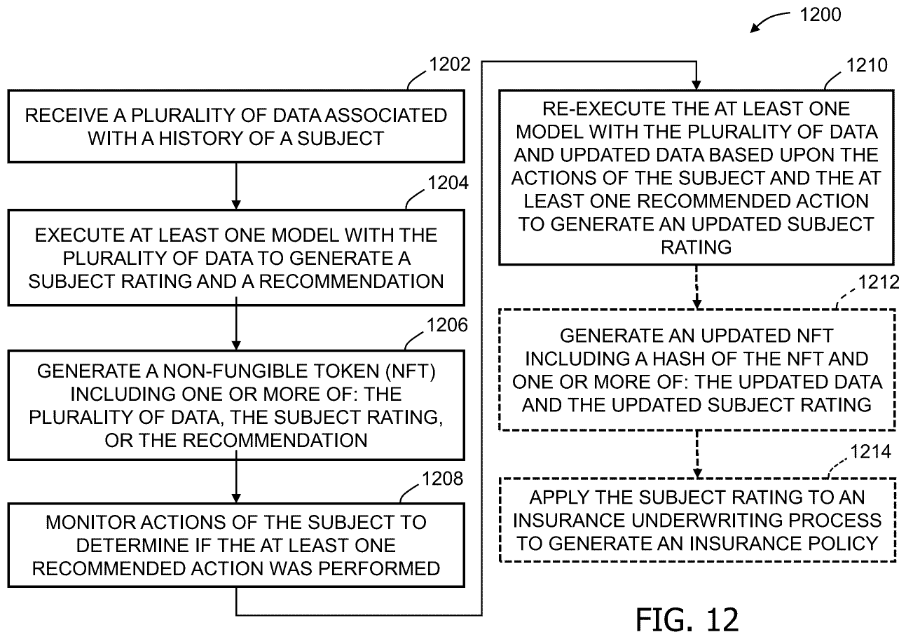

FIG. 12 illustrates a flow chart of an exemplary computer-implemented process 1200 for generating and maintaining one or more rating models, using system 200 shown in FIG. 2. Process 1200 may be implemented by a computing device, for example, TM computing device 202 (also shown in FIG. 2).

In one example embodiment, process 1200 includes receiving 1202 a plurality of data associated with a history of a subject and executing 1204 at least one model with the plurality of data to generate a subject rating for the subject and a recommendation of at least one recommended action that would improve the subject rating. The process also includes generating 1206 a non-fungible token (NFT) including one or more of: the plurality of data, the subject rating, or the recommendation, monitoring 1208 actions of the subject to determine if the at least one recommended action was performed, and re-executing 1210 the at least one model with the plurality of data and updated data based upon the actions of the subject and the at least one recommended action to generate an updated subject rating.

Process 1200 may include additional, fewer, or alternative steps, including those described elsewhere herein.

For example, in some embodiments, process 1200 may further include generating 1212 an updated NFT including a hash of the NFT and one or more of: the updated data and the updated subject rating.

In some embodiments, the subject performs the actions while operating on behalf of an on-demand platform, and monitoring 1208 may include receiving data associated with the actions from a third-party server associated with the on-demand platform.

In some embodiments, the subject is a driver to be insured, and process 1200 may further include applying 1214 the subject rating to an insurance underwriting process to generate an insurance policy associated with the driver.

In still other embodiments, the subject is an individual driver, and the at least one model performs a quantitative assessment of one or more driving behaviors of the driver based upon the plurality of data. Receiving 1202 may include receiving the plurality of data in real-time during usage operation of a vehicle, the plurality of data corresponding to one or more driving behaviors of the driver.

### Exemplary Embodiments & Functionality

In another embodiment, a computer system for generating and maintaining object assessments may be provided. The computer system may include one or more local or remote processors, sensors, transceivers, servers, memory units, mobile devices, augmented reality glasses or headsets, extended or virtual reality headsets, smart glasses or watches, wearables, and/or other electronic or electrical components. In one instance, the computer system may (i) receive a plurality of data associated with an object history of an object; (ii) generate a container file for the object history to include the plurality of data; (iii) generate a non-fungible token (NFT) for the object based upon the container file; (iv) store the NFT and the container file for the object; (v) retrieve the NFT to access the plurality of data; and/or (vi) input the plurality of data to a trained model to receive an initial object assessment as output from the trained model. The computer system may be configured with additional, less, or alternate functionality, including that discussed elsewhere herein.

In another embodiment, a computer system for generating and maintaining subject and object assessments may be provided. The computer system may include one or more local or remote processors, sensors, transceivers, servers, memory units, mobile devices, augmented reality glasses or headsets, extended or virtual reality headsets, smart glasses or watches, wearables, and/or other electronic or electrical components. In one instance, the computer system may (i) receive a plurality of data associated with a subject history of a subject; (ii) generate a container file for the subject history to include the plurality of data; (iii) generate a non-fungible token (NFT) for the subject based upon the container file; (iv) store the NFT and the container file for the subject; (v) retrieve the NFT to access the plurality of data; and/or (vi) input the plurality of data to a trained model to receive an initial subject assessment as output from the trained model. The computer system may be configured with additional, less, or alternate functionality, including that discussed elsewhere herein.

For instance, in some enhancements, the plurality of data includes reference data and sensor data. In some cases, the plurality of data includes sensor data received from sensors disposed within an object being assessed. In some cases, wherein the plurality of data includes sensor data received from sensors disposed within a user computing device operated by the subject.

In some further enhancements, at least one processor is further programmed to: (vii) receive updated data associated with the subject and/or object; (viii) update the container file with at least one of the updated data; and/or (ix) update the NFT based upon the updated container file. In some cases, at least one processor is further programmed to: (x) re-execute the trained model with the updated data; and/or (xi) receive an updated subject and/or object assessment as output from the trained model.

In some enhancements, the subject is an object to be insured, and the at least one processor is further programmed to apply the object assessment to an insurance underwriting process to generate an insurance policy associated with the object.

In some additional enhancements, at least one processor is further programmed to: (a) generate a hash of the container file; and/or (b) store the hash of the container file in the NFT. In some cases, at least one processor is further programmed to: (c) receive additional data for the container file; (d) update the container file with the additional data; (e) generate an updated hash for the updated container file; and/or (f) store the updated hash in the NFT. In some instances, at least one processor is further programmed to: (g) store the updated container file as a new file; and/or (h) link the NFT to the new file. In other cases, at least one processor is further programmed to: (i) retrieve the container file based on the NFT; (j) generate a validation hash of the container file; and/or (k) validate the container file based on the validation hash matching the hash stored in the NFT.

In some enhancements, the subject is an object to be insured, and the subject assessment includes a reliability score related to a value of the object based upon previous usage of the object. In some instances, the at least one processor is further programmed to receive the plurality of data corresponding to usage of the object by a plurality of persons. In some further instances, the at least one processor is further programmed to: (a) receive updated data associated with the object, the updated data indicating an ownership change of the object from a previous owner to a new owner; (b) update the container file with at least one of the updated data; and/or (c) update the NFT based upon the updated container file. In some still further enhancements, the at least one processor is further programmed to cause the trained model to apply a decay factor to data associated with the previous owner of the object in generating subsequent subject assessments of the object.

In additional enhancements, the subject is an individual person, and wherein the subject assessment includes a quantitative assessment of one or more behaviors of the person. In some instances, the at least one processor is further programmed to receive the plurality of data corresponding to the one or more behaviors of the person during usage of multiple objects by the person. In some enhancements, the at least one processor is further programmed to: (a) receive updated data associated with the subject, the updated data indicating an acquisition of a new object by the person; (b) update the container file with at least one of the updated data; and/or (c) update the NFT based upon the updated container file. In some further enhancements, the at least one processor is further programmed to input the updated data into the trained model to generate an updated subject assessment that incorporates data associated with the new object and usage thereof by the person.

In another aspect, a computer-implemented method may provide enhanced object assessment using automated NFT generating and maintenance. The method may be implemented via one or more local or remote processors, sensors, transceivers, servers, memory units, mobile devices, augmented reality glasses or headsets, extended or virtual reality headsets, smart glasses or watches, wearables, and/or other electronic or electrical components. In one instance, the method may include: (i) receiving, via one or more processors and/or associated transceivers, a plurality of data associated with an object history of an object; (ii) generating, via the one or more processors, a container file for the object history to include the plurality of data; (iii) generating, via the one or more processors, a non-fungible token (NFT) for the object based upon the container file; (iv) storing, via the one or more processors, the NFT and the container file for the object; (v) retrieving, via the one or more processors, the NFT to access the plurality of data; and/or (vi) inputting, via the one or more processors, the plurality of data to a trained model to receive an initial object assessment as output from the trained model. The method may include additional, less, or alternate actions, including those discussed elsewhere herein.

In another aspect, a computer-implemented method may provide enhanced subject assessment using automated NFT generating and maintenance. The method may be implemented via one or more local or remote processors, sensors, transceivers, servers, memory units, mobile devices, augmented reality glasses or headsets, extended or virtual reality headsets, smart glasses or watches, wearables, and/or other electronic or electrical components. In one instance, the method may include: (i) receiving, via one or more processors and/or associated transceivers, a plurality of data associated with a subject history of a subject; (ii) generating, via the one or more processors, a container file for the object history to include the plurality of data; (iii) generating, via the one or more processors, a non-fungible token (NFT) for the subject based upon the container file; (iv) storing, via the one or more processors, the NFT and the container file for the subject; (v) retrieving, via the one or more processors, the NFT to access the plurality of data; and/or (vi) inputting, via the one or more processors, the plurality of data to a trained model to receive an initial subject assessment as output from the trained model. The method may include additional, less, or alternate actions, including those discussed elsewhere herein.

In another embodiment, a computer system may be provided. The computer system may include one or more local or remote processors, sensors, transceivers, servers, memory units, mobile devices, augmented reality glasses or headsets, extended or virtual reality headsets, smart glasses or watches, wearables, and/or other electronic or electrical components. In one instance, the computer system may (i) receive a plurality of data associated with a history of a subject; (ii) execute at least one model with the plurality of data of the history of the subject to determine a rating for the subject; (iii) execute the at least one model with the plurality of data of the history of the subject to determine at least one recommendation of at least one action that would improve the rating of the subject; (iv) monitor one or more actions of the subject to determine if the at least one action was performed; and/or (v) update the at least one model based upon the one or more actions of the subject and the at least one action. The computer system may be configured with additional, less, or alternate functionality, including that discussed elsewhere herein.

In some further enhancements, the plurality of data includes historical reference data associated with the subject and sensor data captured by one or more sensors associated with the subject. In additional enhancements, the subject is associated with a third-party application, wherein the plurality of data includes evaluation criteria from the third-party application.

In some further enhancements, the at least one processor is further programmed to: (vi) receive updated data associated with the subject; (vii) re-execute the at least one model with the updated data; and/or (viii) receive an updated rating as output from the trained model.

In some further enhancements, the subject is a driver to be insured and the at least one processor is further programmed to apply the rating to an insurance underwriting process to generate an insurance policy associated with the driver.

In additional enhancements, the rating is based in part on the subject's previous compliance with one or more previous recommendations.

In further enhancements, the plurality of data includes sensor data received from sensors disposed within at least one of a user computing device or a vehicle operated by the subject.

In further enhancements, the subject is an individual driver, and the at least one model performs a quantitative assessment of one or more driving behaviors of the driver.

In further enhancements, the at least one processor is further programmed to receive the plurality of data corresponding to the one or more driving behaviors of the driver during usage operation of a vehicle.

In another aspect, a computer-implemented method may be provided. The computer-implemented method may be performed by a computer device including at least one processor in communication with at least one memory device. The method may include: (i) receiving, via one or more processors and/or associated transceivers, a plurality of data associated with a history of a subject; (ii) executing, via one or more processors and/or associated transceivers, at least one model with the plurality of data of the history of the subject to determine a rating for the subject; (iii) executing, via one or more processors and/or associated transceivers, the at least one model to with the plurality of data of the history of the subject to determine at least one recommendation of at least one action that would improve the rating of the subject; (iv) monitoring, via one or more processors and/or associated transceivers, one or more actions of the subject to determine if the at least one action was performed; and/or (v) updating, via one or more processors and/or associated transceivers, the at least one model based upon the one or more actions of the subject and the at least one action. The computer-implemented method may include additional, fewer, or alternate actions, including those discussed elsewhere herein.

An enhancement of the method may include where the plurality of data includes historical reference data associated with the subject and sensor data captured by one or more sensors associated with the subject.

An enhancement of the method may include where the subject is associated with a third-party application and where the plurality of data includes evaluation criteria from the third-party application.

An enhancement of the method may include (vi) receiving updated data associated with the subject; (vii) re-executing the at least one model with the updated data; and (viii) receiving an updated rating as output from the trained model.

An enhancement of the method may include where the subject is a driver to be insured. The method may further include applying the rating to an insurance underwriting process to generate an insurance policy associated with the driver.

An enhancement of the method may include where the rating is based in part on the subject's previous compliance with one or more previous recommendations.

An enhancement of the method may include where the plurality of data includes sensor data received from sensors disposed within at least one of a user computing device or a vehicle operated by the subject.

An enhancement of the method may include where the subject is an individual driver, and where the at least one model performs a quantitative assessment of one or more driving behaviors of the driver.

An enhancement of the method may include receiving the plurality of data corresponding to the one or more driving behaviors of the driver during usage operation of a vehicle.

In another aspect, at least one non-transitory computer-readable media having computer-executable instructions embodied thereon may be provided. When executed by a computing device including at least one processor in communication with at least one memory device, the computer-executable instructions may cause the at least one processor to: (i) receive a plurality of data associated with a history of a plurality of subjects; (ii) execute at least one model with the plurality of data of the history of the plurality of subjects to determine a rating for each of the plurality of subjects; (iii) execute the at least one model to with the plurality of data of the history of the plurality of subjects to determine at least one recommendation of at least one action that would improve the rating of the corresponding subject; (iv) monitor one or more actions of the corresponding subjects to determine if the at least one action was performed; and/or (v) update the at least one model based upon the one or more actions of the corresponding subjects and the at least one action. The computer-executable instructions may direct additional, less, or alternate functionality, including that discussed elsewhere herein.

The instructions may further include where the plurality of data includes historical reference data associated with the subject and sensor data captured by one or more sensors associated with the subject.

In one aspect, a computer system including at least one processor in communication with at least one memory device may be provided. The at least one processor may be programmed to: (i) receive a plurality of data associated with a history of a subject; (ii) execute at least one model with the plurality of data to generate a subject rating for the subject and a recommendation of at least one recommended action that would improve the subject rating; (iii) generate a non-fungible token (NFT) including one or more of: the plurality of data, the subject rating, or the recommendation; (iv) monitor actions of the subject to determine if the at least one recommended action was performed; and/or (v) re-execute the at least one model with the plurality of data and updated data based upon the actions of the subject and the at least one recommended action to generate an updated subject rating. The computer system may be configured with additional, less, or alternate functionality, including that discussed elsewhere herein.

In one enhancement, the at least one processor may be further programmed to generate an updated NFT including a hash of the NFT and one or more of: the updated data and the updated subject rating.

In another enhancement, the plurality of data may include historical reference data associated with the subject and sensor data captured by one or more sensors associated with the subject.

In a further enhancement, the subject performs the actions while operating on behalf of an on-demand platform, and wherein the at least one processor may be further programmed to receive data associated with the actions from a third-party server associated with the on-demand platform. In some such embodiments, the plurality of data may include evaluation criteria of the subject from the on-demand platform.

In a still further enhancement, the subject is a driver to be insured, and the at least one processor may be further programmed to apply the subject rating to an insurance underwriting process to generate an insurance policy associated with the driver.

In another enhancement, the subject rating may be based in part upon the subject's previous compliance with one or more previous recommendations.

In some enhancements, the plurality of data may include sensor data received from sensors disposed within at least one of a user computing device or a vehicle operated by the subject.

In one enhancement, the subject is an individual driver, and the at least one model may perform a quantitative assessment of one or more driving behaviors of the driver based upon the plurality of data. In some such embodiments, the at least one processor may be further programmed to receive the plurality of data in real-time during usage operation of a vehicle, the plurality of data corresponding to one or more driving behaviors of the driver.

In another aspect, a computer-implemented method implemented using a token management (TM) computing device including at least one processor in communication with at least one memory may be provided. The method may include: (i) receiving a plurality of data associated with a history of a subject; (ii) executing at least one model with the plurality of data to generate a subject rating for the subject and a recommendation of at least one recommended action that would improve the subject rating; (iii) generating a non-fungible token (NFT) including one or more of: the plurality of data, the subject rating, or the recommendation; (iv) monitoring actions of the subject to determine if the at least one recommended action was performed; and/or (v) re-executing the at least one model with the plurality of data and updated data based upon the actions of the subject and the at least one recommended action to generate an updated subject rating. The computer-implemented method may include additional, fewer, or alternate actions, including those discussed elsewhere herein.

In one enhancement, the method may further include generating an updated NFT including a hash of the NFT and one or more of: the updated data and the updated subject rating.

In another enhancement, the subject performs the actions while operating on behalf of an on-demand platform, and the monitoring actions of the subject may include receiving data associated with the actions from a third-party server associated with the on-demand platform.

In a further enhancement, the subject is a driver to be insured, and the method may further include applying the subject rating to an insurance underwriting process to generate an insurance policy associated with the driver.

In a still further enhancement, the subject is an individual driver, and the at least one model may perform. a quantitative assessment of one or more driving behaviors of the driver based upon the plurality of data. In some such embodiments, the receiving a plurality of data may include receiving the plurality of data in real-time during usage operation of a vehicle, the plurality of data corresponding to one or more driving behaviors of the driver.

In yet another aspect, at least one non-transitory computer-readable storage medium storing thereon computer-executable instructions may be provided. When executed by at least one processor, the computer-executable instructions may cause the at least one processor to: (i) receive a plurality of data associated with a history of a subject; (ii) execute at least one model with the plurality of data to generate a subject rating for the subject and a recommendation of at least one recommended action that would improve the subject rating; (iii) generate a non-fungible token (NFT) including one or more of: the plurality of data, the subject rating, or the recommendation; (iv) monitor actions of the subject to determine if the at least one recommended action was performed; and/or (v) re-execute the at least one model with the plurality of data and updated data based upon the actions of the subject and the at least one recommended action to generate an updated subject rating. The computer-executable instructions may direct additional, less, or alternate functionality, including that discussed elsewhere herein.

In one enhancement, the computer-executable instructions may further cause the processor to generate an updated NFT including a hash of the NFT and one or more of: the updated data and the updated subject rating.

In another enhancement, the subject performs the actions while operating on behalf of an on-demand platform, and the computer-executable instructions may further cause the processor to receive data associated with the actions from a third-party server associated with the on-demand platform.

In a further enhancement, the subject rating may be based in part upon the subject's previous compliance with one or more previous recommendations.

In yet another enhancement, the plurality of data may include sensor data received from sensors disposed within at least one of a user computing device or a vehicle operated by the subject.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, in homes, as part of an “internet of things” architecture, or otherwise associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as (but not limited to) reference data, sensor data, mobile device data, vehicle telematics data, and/or intelligent home telematics data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract the relevant personal belonging and/or home feature information for customers from mobile device sensors, vehicle-mounted sensors, home-mounted sensors, and/or other sensor data, vehicle or home telematics data, image data, and/or other data.

In yet another embodiment, a machine-learning module may employ reinforcement learning, which may involve optimizing outputs based upon feedback. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

In one embodiment, a processing element may be trained by providing it with a large sample of conventional analog and/or digital, still and/or moving (i.e., video) image data, telematics data, and/or other data of persons, belongings, household goods, durable goods, appliances, electronics, homes, etc. with known characteristics or features. Such information may include, for example, make or manufacturer and model information.

Based upon these analyses, the processing element may learn how to identify characteristics and patterns that may then be applied to analyzing reference data, sensor data, vehicle or home telematics data, image data, mobile device data, and/or other data.

### Additional Considerations

Described herein are computer systems such as the computer devices and related computer systems forming the enhanced connectivity platform. As described herein, all such computer systems include a processor and a memory. However, any processor in a computer device referred to herein can also refer to one or more processors wherein the processor can be in one computing device or a plurality of computing devices acting in parallel. Additionally, any memory in a computer device referred to herein can also refer to one or more memories wherein the memories can be in one computing device or a plurality of computing devices acting in parallel.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an exemplary embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein may include or be implemented via computer-executable instructions stored on non-transitory computer-readable media or medium.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “exemplary embodiment” or “one embodiment” of the present disclosure are not intended to be interpreted as excluding the existence of additional embodiments that also incorporate the recited features.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

Disjunctive language such as the phrase “at least one of X, Y, or Z,” unless specifically stated otherwise, is generally understood within the context as used to state that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer system including at least one processor in communication with at least one memory device, the at least one processor programmed to:
receive a plurality of data associated with a history of a subject;
execute at least one model with the plurality of data to generate a subject rating for the subject and a recommendation of at least one recommended action that would improve the subject rating;
generate a non-fungible token (NFT) including one or more of: the plurality of data, the subject rating, or the recommendation;
monitor actions of the subject to determine if the at least one recommended action was performed; and
re-execute the at least one model with the plurality of data and updated data based upon the actions of the subject and the at least one recommended action to generate an updated subject rating.

2. The computer system of claim 1, wherein the at least one processor is further programmed to generate an updated NFT including a hash of the NFT and one or more of: the updated data and the updated subject rating.

3. The computer system of claim 1, wherein the plurality of data includes historical reference data associated with the subject and sensor data captured by one or more sensors associated with the subject.

4. The computer system of claim 1, wherein the subject performs the actions while operating on behalf of an on-demand platform, and wherein the at least one processor is further programmed to receive data associated with the actions from a third-party server associated with the on-demand platform.

5. The computer system of claim 4, wherein the plurality of data includes evaluation criteria of the subject from the on-demand platform.

6. The computer system of claim 1, wherein the subject is a driver to be insured, and wherein the at least one processor is further programmed to apply the subject rating to an insurance underwriting process to generate an insurance policy associated with the driver.

7. The computer system of claim 1, wherein the subject rating is based in part upon the subject's previous compliance with one or more previous recommendations.

8. The computer system of claim 1, wherein the plurality of data includes sensor data received from sensors disposed within at least one of a user computing device or a vehicle operated by the subject.

9. The computer system of claim 1, wherein the subject is an individual driver, and wherein the at least one model performs a quantitative assessment of one or more driving behaviors of the driver based upon the plurality of data.

10. The computer system of claim 9, wherein the at least one processor is further programmed to receive the plurality of data in real-time during usage operation of a vehicle, the plurality of data corresponding to one or more driving behaviors of the driver.

11. A computer-implemented method implemented using a token management (TM) computing device including at least one processor in communication with at least one memory, the method comprising:
receiving a plurality of data associated with a history of a subject;
executing at least one model with the plurality of data to generate a subject rating for the subject and a recommendation of at least one recommended action that would improve the subject rating;
generating a non-fungible token (NFT) including one or more of: the plurality of data, the subject rating, or the recommendation;
monitoring actions of the subject to determine if the at least one recommended action was performed; and
re-executing the at least one model with the plurality of data and updated data based upon the actions of the subject and the at least one recommended action to generate an updated subject rating.

12. The computer-implemented method of claim 11, further comprising generating an updated NFT including a hash of the NFT and one or more of: the updated data and the updated subject rating.

13. The computer-implemented method of claim 11, wherein the subject performs the actions while operating on behalf of an on-demand platform, and wherein the monitoring actions of the subject comprises receiving data associated with the actions from a third-party server associated with the on-demand platform.

14. The computer-implemented method of claim 11, wherein the subject is a driver to be insured, and wherein the method further comprises applying the subject rating to an insurance underwriting process to generate an insurance policy associated with the driver.

15. The computer-implemented method of claim 11, wherein the subject is an individual driver, wherein the at least one model performs a quantitative assessment of one or more driving behaviors of the driver based upon the plurality of data, and wherein the receiving a plurality of data comprises receiving the plurality of data in real-time during usage operation of a vehicle, the plurality of data corresponding to one or more driving behaviors of the driver.

16. At least one non-transitory computer-readable storage medium storing thereon computer-executable instructions that, when executed by at least one processor, cause the at least one processor to:
receive a plurality of data associated with a history of a subject;
execute at least one model with the plurality of data to generate a subject rating for the subject and a recommendation of at least one recommended action that would improve the subject rating;
generate a non-fungible token (NFT) including one or more of: the plurality of data, the subject rating, or the recommendation;
monitor actions of the subject to determine if the at least one recommended action was performed; and
re-execute the at least one model with the plurality of data and updated data based upon the actions of the subject and the at least one recommended action to generate an updated subject rating.

17. The non-transitory computer-readable storage medium of claim 16, wherein the computer-executable instructions further cause the processor to generate an updated NFT including a hash of the NFT and one or more of: the updated data and the updated subject rating.

18. The non-transitory computer-readable storage medium of claim 16, wherein the subject performs the actions while operating on behalf of an on-demand platform, and wherein the computer-executable instructions further cause the processor to receive data associated with the actions from a third-party server associated with the on-demand platform.

19. The non-transitory computer-readable storage medium of claim 16, wherein the subject rating is based in part upon the subject's previous compliance with one or more previous recommendations.

20. The non-transitory computer-readable storage medium of claim 16, wherein the plurality of data includes sensor data received from sensors disposed within at least one of a user computing device or a vehicle operated by the subject.
